(19) United States
(12) Patent Application Publication
(10) Pub. No.: US 2026/0112067 A1
(43) Pub. Date: Apr. 23, 2026

(54) Subdivision-based Lifting Wavelet Transform for 3D Mesh Displacements

(71) Applicant: Ofinno, LLC, Reston, VA (US)

(72) Inventors: Marta Milovanovic, Bourg-la-Reine (FR); Chao Cao, Reston, VA (US)

(73) Assignee: Ofinno, LLC, Reston, VA (US)

(21) Appl. No.: 19/362,604

(22) Filed: Oct. 20, 2025

Related U.S. Application Data
(60) Provisional application No. 63/710,023, filed on Oct. 21, 2024.

(51) Int. Cl. G06T 9/00; G06T 3/4084

(52) U.S. Cl. CPC G06T 9/001; G06T 3/4084

(57) ABSTRACT

A decoder obtains, from a bitstream, an indication of a subdivision scheme associated with a level of detail (LOD), of LODs, for a 3D mesh. The decoder selects, based on the indication, a prediction scheme from a plurality of prediction schemes, and an update scheme from a plurality of update schemes. The decoder performs a lifting wavelet transform on coefficients, obtained from the bitstream and representing displacements of vertices of the 3D mesh, at the LOD according to the prediction scheme and the update scheme to reconstruct the displacements.

### CROSS-REFERENCE TO RELATED APPLICATIONS

This application claims the benefit of U.S. Provisional Application No. 63/710,023, filed Oct. 21, 2024, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates an exemplary mesh coding/decoding system in which embodiments of the present disclosure may be implemented.

FIG. 2A illustrates a block diagram of an example encoder for intra encoding a 3D mesh, according to some embodiments.

FIG. 2B illustrates a block diagram of an example encoder for inter encoding a 3D mesh, according to some embodiments.

FIG. 3 illustrates a diagram showing an example decoder.

FIG. 4 is a diagram showing an example process for generating displacements of an input mesh (e.g., an input 3D mesh frame) to be encoded, according to some embodiments.

FIG. 5 illustrates an example process for approximating and encoding a geometry of a 3D mesh, according to some embodiments.

FIG. 6 illustrates an example of vertices of a subdivided mesh (e.g., a subdivided base mesh) corresponding to multiple levels of detail (LODs), according to some embodiments.

FIG. 7A illustrates an example of an image packed with displacements (e.g., displacement fields or vectors) using a packing method, according to some embodiments.

FIG. 7B illustrates an example of the displacement image with labeled LODs, according to some embodiments.

FIG. 8A illustrates an example of a lifting scheme for representing displacement information of a 3D mesh as wavelet coefficients, according to some embodiments.

FIG. 8B illustrates an example of a lifting scheme for representing displacement information of a 3D mesh as wavelet coefficients, according to some embodiments.

FIG. 8C illustrates an example of a lifting scheme for representing displacement information of a 3D mesh as wavelet coefficients, according to some embodiments.

FIG. 9A illustrates an example of a forward lifting scheme applied to coefficients at an LOD N, according to some embodiments.

FIG. 9B illustrates an example of an inverse lifting scheme applied to coefficients at an LOD N, according to some embodiments.

FIG. 10A illustrates an example of using uniform prediction weights to generate a predictor for a coefficient a vertex v, according to some embodiments.

FIG. 10B illustrates an example of using adaptive prediction weights to generate a predictor for a coefficient a vertex v, according to some embodiments.

FIG. 10C illustrates an example of using a normal-based prediction scheme, e.g., an example of an adaptive prediction scheme, according to some embodiments.

FIG. 11 illustrates an example of the benefits of using adaptive update weights instead of to generate updated coefficients, for respective coefficients of respective vertices v1 and v2, respectively, according to some embodiments.

FIG. 12A and FIG. 12B illustrate each iteration of the lifting scheme, described above in FIG. 8B and FIG. 8C, in greater detail, according to some embodiments.

FIG. 13A illustrates an example of midpoint subdivision, according to some embodiments.

FIG. 13B illustrates an example of loop subdivision, according to some embodiments.

FIG. 14 illustrates a flowchart of a method for performing a lifting wavelet transform, according to some embodiments.

FIG. 15 illustrates a block diagram of an exemplary computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of pixels that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color. Compared to traditional visual data, volumetric visual data may provide a more immersive way to experience visual data. For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is three dimensional (3D) meshes (hereinafter referred to as a mesh or a mesh frame). A mesh frame (or mesh) comprises a collection of points in three-dimensional (3D) space, also referred to as vertices. Each vertex in a mesh comprises geometry information that indicates the vertex's position in 3D space. For example, the geometry information may indicate the vertex's position in 3D space using three Cartesian coordinates (x, y, and z). Further the mesh may comprise geometry information indicating a plurality of triangles. Each triangle comprises three vertices connected by three edges and a face. One or more types of attribute information may be stored for each face (of a triangle). Attribute information may indicate a property of a face's visual appearance. For example, attribute information may indicate a texture (e.g., color) of the face, a material type of the face, transparency information of the face, reflectance information of the face, a normal vector to a surface of the face, a velocity at the face, an acceleration at the face, a time stamp indicating when the face (and/or vertex) was captured, or a modality indicating how the face (and/or vertex) was captured (e.g., running, walking, or flying). In another example, a face (or vertex) may comprise light field data in the form of multiple view-dependent texture information. Light field data may be another type of optional attribute information.

The triangles (e.g., represented by vertexes and edges) in a mesh may describe an object or a scene. For example, the triangles in a mesh may describe the external surface and/or the internal structure of an object or scene. The object or scene may be synthetically generated by a computer or may be generated from the capture of a real-world object or scene. The geometry information of a real world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Mesh data may be in the form of a mesh frame that describes an object or scene captured at a particular time instance or in the form of a sequence of mesh frames (referred to as a mesh sequence or mesh video) that describes an object or scene captured at multiple different time instances.

The data size of a mesh frame or sequence in addition with one or more types of attribute information may be too large for storage and/or transmission in many applications. For example, a single mesh frame may comprise thousands or tens or hundreds of thousands of triangles, where each triangle (e.g., vertexes and/or edges) comprises geometry information and one or more optional types of attribute information. The geometry information of each vertex may comprise three Cartesian coordinates (x, y, and z) that are each represented, for example, using 8 bits or 24 bits in total. The attribute information of each point may comprise a texture corresponding to three color components (e.g., R, G, and B color components) that are each represented, for example, using 8 bits or 24 bits in total. A single vertex therefore comprises 48 bits of information in this example, with 24 bits of geometry information and 24 bits of texture. Encoding may be used to compress the size of a mesh frame or sequence to provide for more efficient storage and/or transmission. Decoding may be used to decompress a compressed mesh frame or sequence for display and/or other forms of consumption (e.g., by a machine learning based device, neural network based device, artificial intelligence based device, or other forms of consumption by other types of machine based processing algorithms and/or devices).

Compression of meshes may be lossy (e.g., introducing differences relative to the original data) for the distribution to and visualization by an end-user, for example on AR/VR glasses or any other 3D-capable device. Lossy compression allows for a very high ratio of compression but incurs a trade-off between compression and visual quality perceived by the end-user. Other frameworks, like medical or geological applications, may require lossless compression to avoid altering the decompressed meshes.

Volumetric visual data may be stored after being encoded into a bitstream in a container, for example, a file server in the network. The end-user may request for a specific bitstream depending on the user's requirement. The user may also request for adaptive streaming of the bitstream where the trade-off between network resource consumption and visual quality perceived by the end-user is taken into consideration by an algorithm.

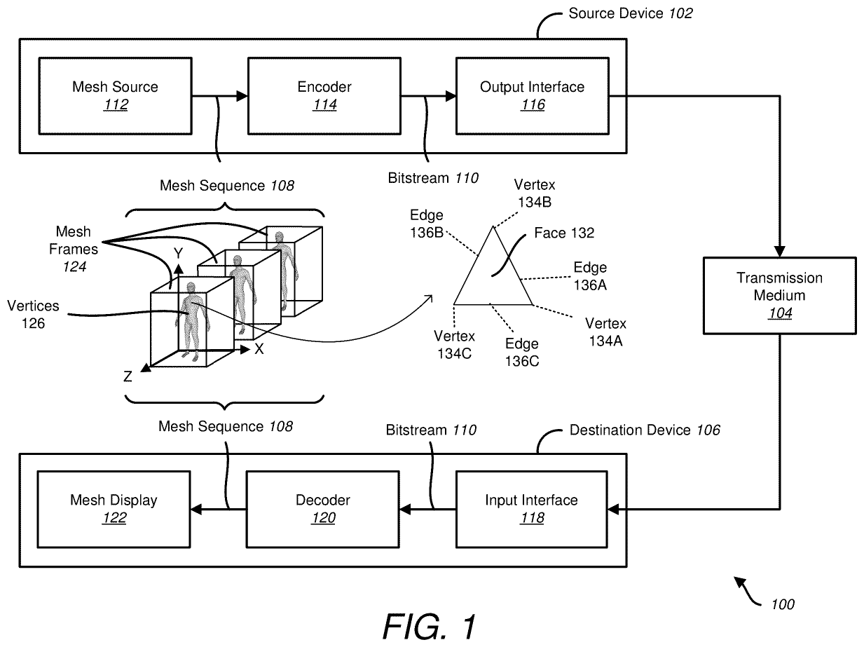

FIG. 1 illustrates an exemplary mesh coding/decoding system 100 in which embodiments of the present disclosure may be implemented. Mesh coding/decoding system 100 comprises a source device 102, a transmission medium 104, and a destination device 106. Source device 102 encodes a mesh sequence 108 into a bitstream 110 for more efficient storage and/or transmission. Source device 102 may store and/or transmit bitstream 110 to destination device 106 via transmission medium 104. Destination device 106 decodes bitstream 110 to display mesh sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode mesh sequence 108 into bitstream 110, source device 102 may comprise a mesh source 112, an encoder 114, and an output interface 116. Mesh source 112 may provide or generate mesh sequence 108 from a capture of a natural scene and/or a synthetically generated scene. A synthetically generated scene may be a scene comprising computer generated graphics. Mesh source 112 may comprise one or more mesh capture devices (e.g., one or more laser scanning devices, structured light scanning devices, modulated light scanning devices, and/or passive scanning devices), a mesh archive comprising previously captured natural scenes and/or synthetically generated scenes, a mesh feed interface to receive captured natural scenes and/or synthetically generated scenes from a mesh content provider, and/or a processor to generate synthetic mesh scenes.

As shown in FIG. 1, a mesh sequence 108 may comprise a series of mesh frames 124. A mesh frame describes an object or scene captured at a particular time instance. Mesh sequence 108 may achieve the impression of motion when a constant or variable time is used to successively present mesh frames 124 of mesh sequence 108. A (3D) mesh frame comprises a collection of vertices 126 in 3D space and geometry information of vertices 126. A 3D mesh may comprise a collection of vertices, edges, and faces that define the shape of a polyhedral object. Further, the mesh frame comprises a plurality of triangles (e.g., polygon triangles). For example, a triangle may include vertices 134A-C and edges 136A-C and a face 132. The faces usually consist of triangles (triangle mesh), Quadrilaterals (Quads), or other simple convex polygons (n-gons), since this simplifies rendering, but may also be more generally composed of concave polygons, or even polygons with holes. Each of vertices 126 may comprise geometry information that indicates the point's position in 3D space. For example, the geometry information may indicate the point's position in 3D space using three Cartesian coordinates (x, y, and z). For example, the geometry information may indicate the plurality of triangles with each comprising three vertices of vertices 126. One or more of the triangles may further comprise one or more types of attribute information. Attribute information may indicate a property of a point's visual appearance. For example, attribute information may indicate a texture (e.g., color) of a face, a material type of a face, transparency information of a face, reflectance information of a face, a normal vector to a surface of a face, a velocity at a face, an acceleration at a face, a time stamp indicating when a face was captured, a modality indicating when a face was captured (e.g., running, walking, or flying). In another example, one or more of the faces (or triangles) may comprise light field data in the form of multiple view-dependent texture information. Light field data may be another type of optional attribute information. Color attribute information of one or more of the faces may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

In some embodiments, a 3D mesh (e.g., one of mesh frames 124) may be a static or a dynamic mesh. In some examples, the 3D mesh may be represented (e.g., defined) by connectivity information, geometry information, and texture information (e.g., texture coordinates and texture connectivity). In some embodiments, the geometry information may represent locations of vertices of the 3D mesh in 3D space and the connectivity information may indicate how the vertices are to be connected together to form polygons (e.g., triangles) that make up the 3D mesh. Also, the texture coordinates indicate locations of pixels in a 2D image that correspond to vertices of a corresponding 3D mesh (or a sub-mesh of the 3D mesh). In some examples, patch information may indicate how the texture coordinates defined with respect to a 2D bounding box map into a 3D space of a 3D bounding box associated with the patch based on how the points were projected onto a projection plane for the patch. Also, the texture connectivity information may indicate how the vertices represented by the texture coordinates are to be connected together to form polygons of the 3D mesh (or sub-meshes). For example, each texture or attribute patch of the texture image may corresponds to a corresponding sub-mesh defined using texture coordinates and texture connectivity.

In some embodiments, for each 3D mesh, one or multiple 2D images may represent the textures or attributes associated with the mesh. For example, the texture information may include geometry information listed as X, Y, and Z coordinates of vertices and texture coordinates listed as 2D dimensional coordinates corresponding to the vertices. The example texture mesh may include texture connectivity information that indicates mappings between the geometry coordinates and texture coordinates to form polygons, such as triangles. For example, a first triangle may be formed by three vertices, where a first vertex is defined as the first geometry coordinate (e.g. 64.062500, 1237.739990, 51.757801), which corresponds with the first texture coordinate (e.g. 0.0897381, 0.740830). A second vertex of the triangle may be defined as the second geometry coordinate (e.g. 59.570301, 1236.819946, 54.899700), which corresponds with the second texture coordinate (e.g. 0.899059, 0.741542). Finally, a third vertex of the triangle may correspond to the third listed geometry coordinate which matches with the third listed texture coordinate. However, note that in some instances a vertex of a polygon, such as a triangle, may map to a set of geometry coordinates and texture coordinates that may have different index positions in the respective lists of geometry coordinates and texture coordinates. For example, the second triangle has a first vertex corresponding to the fourth listed set of geometry coordinates and the seventh listed set of texture coordinates. A second vertex corresponding to the first listed set of geometry coordinates and the first set of listed texture coordinates and a third vertex corresponding to the third listed set of geometry coordinates and the ninth listed set of texture coordinates.

Encoder 114 may encode mesh sequence 108 into bitstream 110. To encode mesh sequence 108, encoder 114 may apply one or more prediction techniques to reduce redundant information in mesh sequence 108. Redundant information is information that may be predicted at a decoder and therefore may not be needed to be transmitted to the decoder for accurate decoding of mesh sequence 108. For example, encoder 114 may convert attribute information (e.g., texture information) of one or more of mesh frames 124 from 3D to 2D and then apply one or more 2D video encoders or encoding methods to the 2D images. For example, any one of multiple different proprietary or standardized 2D video encoders/decoders may be used, including International Telecommunications Union Telecommunication Standardization Sector (ITU-T) H.1263, ITU-T H.1264 and Moving Picture Expert Group (MPEG)-4 Visual (also known as Advanced Video Coding (AVC)), ITU-T H.1265 and MPEG-H Part 2 (also known as High Efficiency Video Coding (HEVC), ITU-T H.1265 and MPEG-I Part 3 (also known as Versatile Video Coding (VVC)), the WebM VP8 and VP9 codecs, and AOMedia Video 1 (AVI). Encoder 114 may encode geometry of mesh sequence 108 based on video dynamic mesh coding (V-DMC). V-DMC specifies the encoded bitstream syntax and semantics for transmission or storage of a mesh sequence and the decoder operation for reconstructing the mesh sequence from the bitstream.

Output interface 116 may be configured to write and/or store bitstream 110 onto transmission medium 104 for transmission to destination device 106. In addition, or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition, or alternatively, transmission medium 104 may comprise one or more networks (e.g., the Internet) or file servers configured to store and/or transmit encoded video data.

To decode bitstream 110 into mesh sequence 108 for display or other forms of consumption, destination device 106 may comprise an input interface 118, a decoder 120, and a mesh display 122. Input interface 118 may be configured to read bitstream 110 stored on transmission medium 104 by source device 102. In addition, or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode mesh sequence 108 from encoded bitstream 110. To decode attribute information (e.g., textures) of mesh sequence 108, decoder 120 may reconstruct the 2D images compressed using one or more 2D video encoders. Decoder 120 may then reconstruct the attribute information of 3D mesh frames 124 from the reconstructed 2D images. In some examples, decoder 120 may decode a mesh sequence that approximates mesh sequence 108 due to, for example, lossy compression of mesh sequence 108 by encoder 114 and/or errors introduced into encoded bitstream 110 during transmission to destination device 106. Further, decoder 120 may decode geometry of mesh sequence 108 from encoded bitstream 110, as will be further described below. Then, one or more of decoded attribute information may be applied to decoded mesh frames of mesh sequence 108.

Mesh display 122 may display mesh sequence 108 to a user. Mesh display 122 may comprise a cathode rate tube (CRT) display, a liquid crystal display (LCD), a plasma display, a light emitting diode (LED) display, a 3D display, a holographic display, a head mounted display, or any other display device suitable for displaying mesh sequence 108.

It should be noted that mesh coding/decoding system 100 is presented by way of example and not limitation. In the example of FIG. 1, mesh coding/decoding system 100 may have other components and/or arrangements. For example, mesh source 112 may be external to source device 102. Similarly, mesh display 122 may be external to destination device 106 or omitted altogether where mesh sequence is intended for consumption by a machine and/or storage device. In another example, source device 102 may further comprise a mesh decoder and destination device 106 may comprise a mesh encoder. In such an example, source device 102 may be configured to further receive an encoded bit stream from destination device 106 to support two-way mesh transmission between the devices.

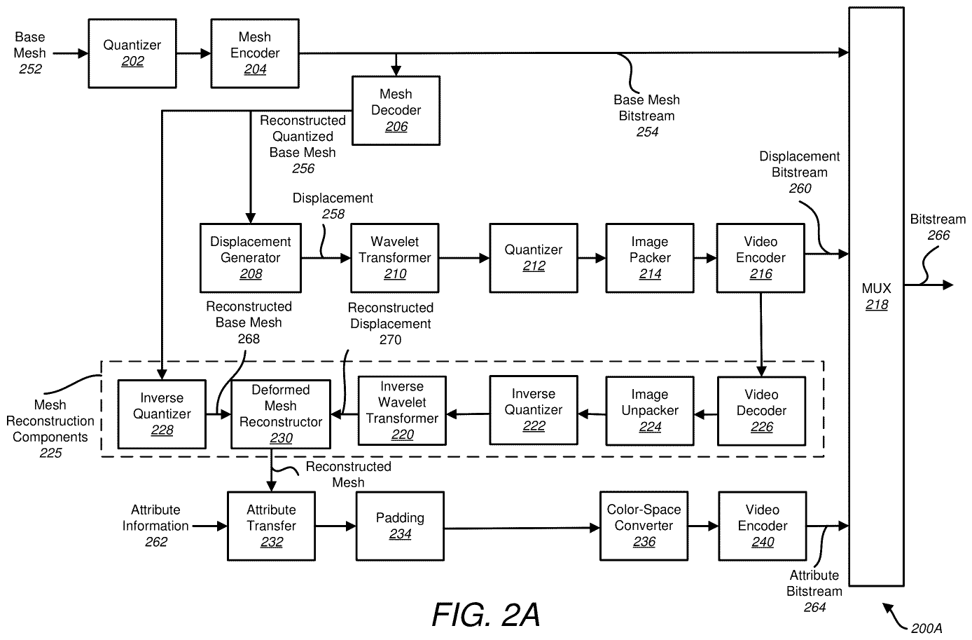

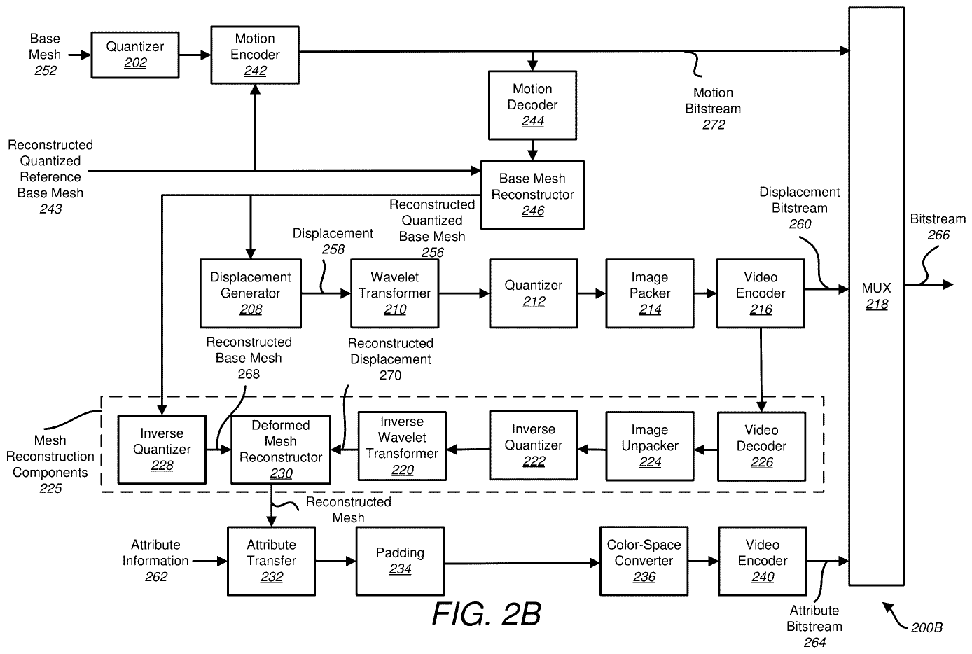

FIG. 2A illustrates a block diagram of an example encoder 200A for intra encoding a 3D mesh, according to some embodiments. For example, an encoder (e.g., encoder 114) may comprise encoder 200A.

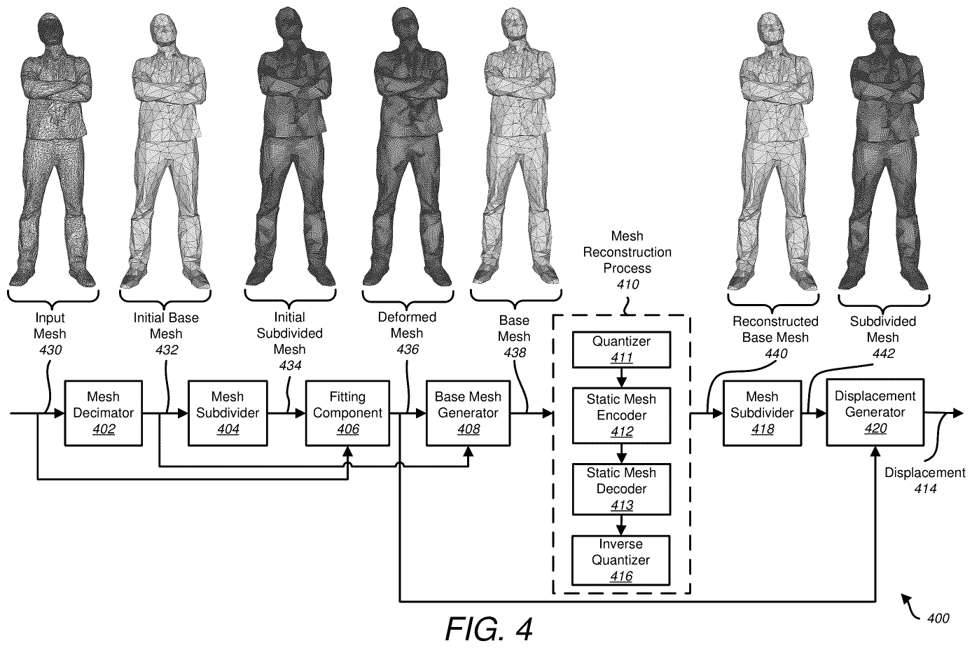

In some examples, a mesh sequence (e.g., mesh sequence 108) may include a set of mesh frames (e.g., mesh frames 124) that may be individually encoded and decoded. As will be further described below with respect to FIG. 4, a base mesh 252 may be determined (e.g., generated) from a mesh frame (e.g., an input mesh) through a decimation process. In the decimation process, the mesh topology of the mesh frame may be reduced to determine the base mesh (e.g., a decimated mesh or decimated base mesh). A mesh encoder 204 may encode base mesh 252, whose geometry information (e.g., vertices) may be quantized by quantizer 202, to generate a base mesh bitstream 254. In some examples, base mesh encoder 204 may be an existing encoder such as Draco or Edgebreaker.

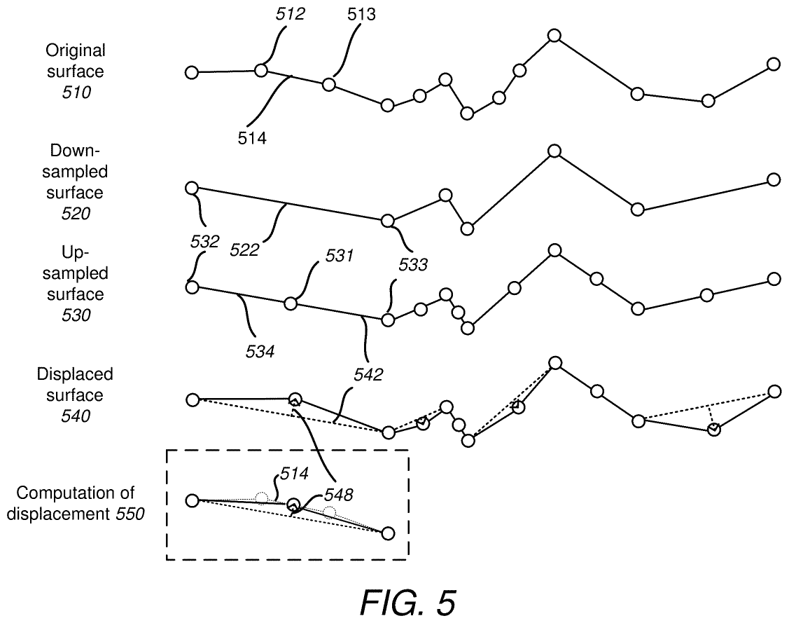

Displacement generator 208 may generate displacements for vertices of the mesh frame based on base mesh 252, as will be further explained below with respect to FIGS. 4 and 5. In some examples, the displacements are determined based on a reconstructed base mesh 256. Reconstructed base mesh 256 may be determined (e.g., output or generated) by mesh decoder 206 that decodes the encoded base mesh (e.g., in base mesh bitstream 254) determined (e.g., output or generated) by mesh encoder 204. Displacement generator 208 may subdivide reconstructed base mesh 256 using a subdivision scheme (e.g., subdivision algorithm) to determine a subdivided mesh (e.g., a subdivided base mesh). Displacement 258 may be determined based on fitting the subdivided mesh to an original input mesh surface. For example, displacement 258 for a vertex in the mesh frame may include displacement information (e.g., a displacement vector) that indicates a displacement from the position of the corresponding vertex in the subdivided mesh to the position of the vertex in the mesh frame.

Displacement 258 may be transformed by wavelet transformer 210 to generate wavelet coefficients (e.g., transformation coefficients) representing the displacement information and that may be more efficiently encoded (and subsequently decoded). The wavelet coefficients may be quantized by quantizer 212 and packed (e.g., arranged) by image packer 214 into a picture (e.g., one or more images or picture frames) to be encoded by video encoder 216. Mux 218 may combine (e.g., multiplex) the displacement bitstream 260 output by video encoder 216 together with base mesh bitstream 254 to form bitstream 266.

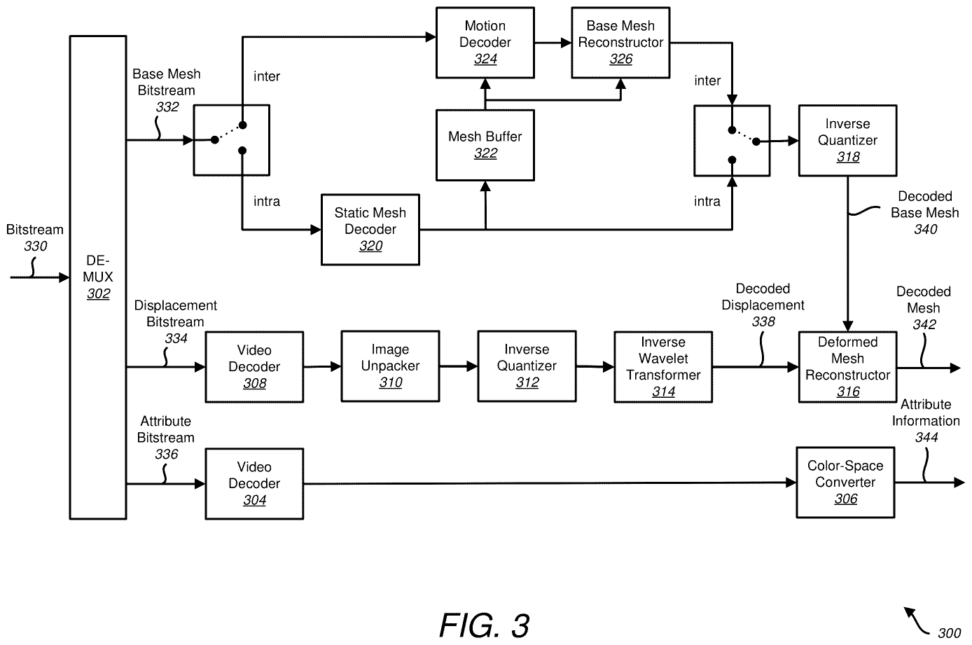

Attribute information 262 (e.g., color, texture, etc.) of the mesh frame may be encoded separately from the geometry information of the mesh frame described above. In some examples, attribute information 262 of the mesh frame may be represented (e.g., stored) by an attribute map (e.g., texture map) that associates each vertex of the mesh frame with corresponding attributes information of that vertex. Attribute transfer 232 may re-parameterize attribute information 262 in the attribute map based on reconstructed mesh determined (e.g., generated or output) from mesh reconstruction components 225. Mesh reconstruction components 225 perform inverse or decoding functions and may be the same or similar components in a decoder (e.g., decoder 300 of FIG. 3). For example, inverse quantizer 228 may inverse quantize reconstructed base mesh 256 to determine (e.g., generate or output) reconstructed base mesh 268. Video decoder 226, image unpacker 224, inverse quantizer 222, and inverse wavelet transformer 220 may perform the inverse functions as that of video encoder 216, image packer 214, quantizer 212, and wavelet transformer 210, respectively. Accordingly, reconstructed displacement 270, corresponding to displacement 258, may be generated from applying video decoder 226, image unpacker 224, inverse quantizer 222, and inverse wavelet transformer 220 in that order. Deformed mesh reconstructor 230 may determine the reconstructed mesh, corresponding to the input mesh frame, based on reconstructed base mesh 268 and reconstructed displacement 270. In some examples, the reconstructed mesh may be the same decoded mesh determined from the decoder based on decoding base mesh bitstream 254 and displacement bitstream 260.

Attribute information of the re-parameterized attribute map may be packed in images (e.g., 2D images or picture frames) by padding component 234. Padding component 234 may fill (e.g., pad) portions of the images that do not contain attribute information. In some examples, color-space converter 236 may translate (e.g., convert) the representation of color (e.g., an example of attribute information 262) from a first format to a second format (e.g., from RGB444 to YUV420) to achieve improved rate-distortion (RD) performance when encoding the attribute maps. In an example, color-space converter 236 may also perform chroma subsampling to further increase encoding performance. Finally, video encoder 240 encodes the images (e.g., pictures frames) representing attribute information 262 of the mesh frame to determine (e.g., generate or output) attribute bitstream 264 multiplexed by mux 218 into bitstream 266. In some examples, video encoder 240 may be an existing 2D video compression encoder such as an HEVC encoder or a VVC encoder.

FIG. 2B illustrates a block diagram of an example encoder 200B for inter encoding a 3D mesh, according to some embodiments. For example, an encoder (e.g., encoder 114) may comprise encoder 200B. As shown in FIG. 2B, encoder 200B comprises many of the same components as encoder 200A. In contrast to encoder 200A, encoder 200B does not include mesh encoder 204 and mesh decoder 206, which correspond to coders for static 3D meshes. Instead, encoder 200B comprises a motion encoder 242, a motion decoder 244, and a base mesh reconstructor 246. Motion encoder 242 may determine a motion field (e.g., one or more motion vectors (MVs)) that, when applied to a reconstructed quantized reference base mesh 243, best approximates base mesh 252.

The determined motion field may be encoded in bitstream 266 as motion bitstream 272. In some examples, the motion field (e.g., a motion vector in the x, y, and z directions) may be entropy coded as a codeword (e.g., for each directional component) resulting from a coding scheme such as a unary, a Golomb code (e.g., Exp-Golomb code), a Rice code, or a combination thereof. In some examples, the codeword may be arithmetically coded, e.g., using CABAC. A prefix part of the codeword may be context coded and a suffix part of the coded may be bypass coded. In some examples, a sign bit for each directional component of the motion vector may be coded separately.

In some examples, motion bitstream 272 may further include indication of the selected reconstructed quantized reference base mesh 243.

In some examples, motion bitstream 272 may be decoded by motion decoder 244 and used by base mesh reconstructor 246 to generate reconstructed quantized base mesh 256. For example, base mesh reconstructor 246 may apply the decoded motion field to reconstructed quantized reference base mesh 243 to determine (e.g., generate) reconstructed quantized base mesh 256.

In some examples, a reconstructed quantized reference base mesh m′(j) associated with a reference mesh frame with index j may be used to predict the base mesh m(i) associated with the current frame with index i. Base meshes m(i) and m(j) may comprise the same: number of vertices, connectivity, texture coordinates, and texture connectivity. The positions of vertices may differ between base meshes m(i) and m(j).

In some examples, the motion field f(i) may be computed by considering the quantized version of m(i) and the reconstructed quantized base mesh m′(j). Base mesh m′(j) may have a different number of vertices than m(j) (e.g., vertices may have been merged or removed). Therefore, the encoder may track the transformation applied to m(j) to determine (e.g., generate or obtain) m′(j) and applies it to m(i). This transformation may enable a 1-to-1 correspondence between vertices of base mesh m′(j) and the transformed and quantized version of base mesh m(i), denoted as m\hat{ }* (i). The motion field f(i) may be computed by subtracting the quantized positions Pos(i,v) of the vertex v of m\hat{ }* (i) from the positions Pos(j,v) of the vertex v of m′(j) as follows: f(i,v)=Pos(j,v)−Pos(i,v). The motion field may be further predicted by using the connectivity information of base mesh m′(j) and the prediction residuals may be entropy encoded.

In some examples, since the motion field compression process may be lossy, a reconstructed motion field denoted as f(i) may be computed by applying the motion decoder component. A reconstructed quantized base mesh m′(i) may then be computed by adding the motion field to the positions of vertices in base mesh m′(j). To better exploit temporal correlation in the displacement and attribute map videos, inter prediction may be enabled in the video encoder.

In some embodiments, an encoder (e.g., encoder 114) may comprise encoder 200A and encoder 200B.

FIG. 3 illustrates a diagram showing an example decoder 300. Bitstream 330, which may correspond to bitstream 266 in FIGS. 2A and 2B and may be received in a binary file, may be demultiplexed by de-mux 302 to separate bitstream 330 into base mesh bitstream 332, displacement bitstream 334, and attribute bitstream 336 carrying base mesh geometry information, displacement geometry information, and attribute information, respectively. Attribute bitstream 336 may include one or more attribute map sub-streams for each attribute type.

In some examples, for inter decoding, the bitstream is de-multiplexed into separate sub-streams, including: a motion sub-stream, a displacement sub-stream for positions and potentially for each vertex attribute, zero or more attribute map sub-streams, and an atlas sub-stream containing patch information in the same manner as in V3C/V-PCC.

In some examples, base mesh bitstream 332 may be decoded in an intra mode or an inter mode. In the intra mode, static mesh decoder 320 may decode base mesh bitstream 332 (e.g., to generate reconstructed base mesh m′(i)) that is then inverse quantized by inverse quantizer 318 to determine (e.g., generate or output) decoded base mesh 340 (e.g., reconstructed quantized base mesh m″(i)). In some examples, static mesh decoder 320 may correspond to mesh decoder 206 of FIG. 2A.

In some examples, in the inter mode, base mesh bitstream 332 may include motion field information that is decoded by motion decoder 324. In some examples, motion decoder 324 may correspond to motion decoder 244 of FIG. 2B. For example, motion decoder 324 may entropy decode base mesh bitstream 332 to determine motion field information. In the inter mode, base mesh bitstream 332 may indicate a previous base mesh (e.g., reference base mesh m′(j)) decoded by static mesh decoder 320 and stored (e.g., buffered) in mesh buffer 322. Base mesh reconstructor 326 may generate a quantized reconstructed base mesh m′(i) by applying the decoded motion field (output by motion decoder 324) to the previously decoded (e.g., reconstructed) base mesh m′(j) stored in mesh buffer 322. In some examples, base mesh reconstructor 326 may correspond to base mesh reconstructor 246 of FIG. 2B. The quantized reconstructed base mesh may be inverse quantized by inverse quantizer 318 to determine (e.g., generate or output) decoded base mesh 340 (e.g., reconstructed base mesh m″(i)). In some examples, decoded base mesh 340 may be the same as reconstructed base mesh 268 in FIGS. 2A and 2B.

In some examples, decoder 300 includes video decoder 308, image unpacker 310, inverse quantizer, and inverse wavelet transformer 314 that determines (e.g., generates) decoded displacement 338 from displacement bitstream 334. Video decoder 308, image unpacker 310, inverse quantizer, and inverse wavelet transformer 314 correspond to video decoder 226, image unpacker 224, inverse quantizer 222, and inverse wavelet transformer 220, respectively, and perform the same or similar operations. For example, the picture frames (e.g., images) received in displacement bitstream 334 may be decoded by video decoder 308, the displacement information may be unpacked by image unpacker 310 from the decoded image, inverse quantized by inverse quantizer 312 to determined inverse quantized wavelet coefficients representing encoded displacement information. Then, the unquantized wavelet coefficients may be inverse transformed by inverse wavelet transformer 314 to determine decoded displacement d″(i). In other words decoded displacement 338 (e.g., decoded displacement field d″(i)) may be the same as reconstructed displacement 270 in FIGS. 2A and 2B.

Deformed mesh reconstructor 316, which corresponds to deformed mesh reconstructor 230, may determine (e.g., generate or output) decoded mesh 342 (M″(i)) based on decoded displacement 338 and decoded base mesh 340. For example, deformed mesh reconstructor 316 may combine (e.g., add) decoded displacement 338 to a subdivided decoded mesh 340 to determine decoded mesh 342.

In some examples, decoder 300 includes video decoder 304 that decodes attribute bitstream 336 comprising encoded attribute information represented (e.g., stored) in 2D images (or picture frames) to determined attribute information 344 (e.g., decoded attribute information or reconstructed attribute information). In some examples, video decoder 304 may be an existing 2D video compression decoder such as an HEVC decoder or a VVC decoder. Decoder 300 may include a color-space converter 306, which may revert the color format transformation performed by color-space converter 236 in FIGS. 2A and 2B.

FIG. 4 is a diagram 400 showing an example process (e.g., a pre-processing operations) for generating displacements 414 of an input mesh 430 (e.g., an input 3D mesh frame) to be encoded, according to some embodiments. In some examples, displacements 414 may correspond to displacement 258 shown in FIG. 2A and FIG. 2B.

In diagram 400, a mesh decimator 402 determines (e.g., generates or outputs) an initial base mesh 432 based on (e.g., using) input mesh 430. In some examples, the initial base mesh 432 may be determined (e.g., generated) from the input mesh 432 through a decimation process. In the decimation process, the mesh topology of the mesh frame may be reduced to determine the initial base mesh (which may be referred to as a decimated mesh or decimated base mesh). As will be illustrated in FIG. 5, the decimation process may involve a down sampling process to remove vertices from the input mesh 432 so that a small portion (e.g., 6% or less) of the vertices in the input mesh 430 may remain in the initial base mesh 432.

Mesh subdivider 404 applies a subdivision scheme to generate initial subdivided mesh 434. As will be discussed in more detail with regard to FIG. 5, the subdivision scheme may involve upsampling the initial base mesh 432 to add more vertices to the 3D mesh based on the topology and shape of the original mesh to generate the initial subdivided mesh 434.

Fitting component 406 may fit the initial subdivided mesh to determine a deformed mesh 436 that may more closely approximate the surface of input mesh 430. As will be discussed in more detail with respect to FIG. 5, the fitting may be performed by moving vertices of the initial subdivided mesh 434 towards the surfaces of the input mesh 430 so that the subdivided mesh 434 can be used to approximate the input mesh 430. In some implementations, the fitting is performed by moving each vertex of the initial subdivided mesh 434 along the normal direction of the vertex until the vertex intersects with a surface of the input mesh 430. The resulting mesh is the deformed mesh 436. The normal direction may be indicated by a vertex normal at the vertex, which may be obtained from face normals of triangles formed by the vertex.

Base mesh generator 408 may perform another fitting process to generate a base mesh 438 from the initial base mesh 432. For example, the base mesh generator 408 may deform the initial base mesh 432 according to the deformed mesh 436 so that the initial base mesh 432 is close to the deformed mesh 436. In some implementations, the fitting process may be performed in a similar manner to the fitting component 406. For example, the base mesh generator 408 may move each of the vertices in the initial base mesh 432 along its normal direction (e.g., based on the vertex normal at each vertex) until the vertex reaches a surface of the deformed mesh 436. The output of this process is the base mesh 438.

Base mesh 438 may be output to a mesh reconstruction process 410 to generate a reconstructed base mesh 440. Reconstructed base mesh 440 may be subdivided by mesh subdivider 418 and the subdivided mesh 442 may be input to displacement generator 420 to generate (e.g., determine or output) displacement 414, as further described below with respect to FIG. 5. In some examples, mesh subdivider 418 may apply the same subdivision scheme as that applied by mesh subdivider 404. In these examples, vertices in the subdivided mesh 442 have a one-to-one correspondence with the vertices in the deformed mesh 436. As such, the displacement generator 420 may generate the displacements 414 by calculating the difference between each vertex of the subdivided mesh 442 and the corresponding vertex of the deformed mesh 436. In some implementations, the difference may be projected onto a normal direction of the associated vertex and the resulting vector is the displacement 414. In this way, only the sign and magnitude of the displacement 414 need to be encoded in the bitstream, thereby increasing the coding efficiency. In addition, because the base mesh 438 has been fitted toward the deformed mesh 436, the displacements 414 between the deformed mesh 436 and the subdivided mesh 442 (generated from the reconstructed base mesh 440) will have small magnitudes, which further reduces the payload and increases the coding efficiency.

In some examples, one advantage of applying the subdivision process is to allow for more efficient compression, while offering a faithful approximation of the original input mesh 430 (e.g., surface or curve of the original input mesh 430). The compression efficiency may be obtained because the base mesh (e.g., decimated mesh) has a lower number of vertices compared to the number of vertices of input mesh 430 and thus requires a fewer number of bits to be encoded and transmitted. Additionally, the subdivided mesh may be automatically generated by the decoder once the base mesh has been decoded without any information needed from the encoder other than a subdivision scheme (e.g., subdivision algorithm) and parameters for the subdivision (e.g., a subdivision iteration count). The reconstructed mesh may be determined by decoding displacement information (e.g., displacement vectors) associated with vertices of the subdivided mesh (e.g., subdivided curves/surfaces of the base mesh). Not only does the subdivision process allow for spatial/quality scalability, but also the displacements may be efficiently coded using wavelet transforms (e.g., wavelet decomposition), which further increases compression performance.

In some embodiments, mesh reconstruction process 410 includes components for encoding and then decoding base mesh 438. FIG. 4 shows an example for the intra mode, in which mesh reconstruction process 410 may include quantizer 411, static mesh encoder 412, static mesh decoder 413, and inverse quantizer 416, which may perform the same or similar operations as quantizer 202, mesh encoder 204, mesh decoder 206, and inverse quantizer 228, respectively, from FIG. 2A. In the inter mode, mesh reconstruction process 410 may include quantizer 202, motion encoder 242, motion decoder 244, base mesh reconstructor 246, and inverse quantizer 228.

FIG. 5 illustrates an example process for approximating and encoding a geometry of a 3D mesh, according to some embodiments. For illustrative purposes, the 3D mesh is shown as 2D curves. An original surface 510 of the 3D mesh (e.g., a mesh frame) includes vertices (e.g., points) and edges that connect neighboring vertices. For example, point 512 and point 513 are connected by an edge corresponding to surface 514.

In some examples, a decimation process (e.g., a down-sampling process or a decimation/down-sampling scheme) may be applied to an original surface 510 of the original mesh to generate a down-sampled surface 520 of a decimated (or down-sampled) mesh. In the context of mesh compression, decimation refers to the process of reducing the number of vertices in a mesh while preserving its overall shape and topology. For example, original mesh surface 510 is decimated into a surface 520 with fewer samples (e.g., vertices and edges) but still retains the main features and shape of the original mesh surface 510. This down-sampled surface 520 may correspond to a surface of the base mesh (e.g., a decimated mesh).

In some examples, after the decimation process, a subdivision process (e.g., subdivision scheme or subdivision algorithm) may be applied to down-sampled surface 520 to generate an up-sampled surface 530 with more samples (e.g., vertices and edges). Up-sampled surface 530 may be part of the subdivided mesh (e.g., subdivided base mesh) resulting from subdividing down-sampled surface 520 corresponding to a base mesh.

Subdivision is a process that is commonly used after decimation in mesh compression to improve the visual quality of the compressed mesh. The subdivision process involves adding new vertices and faces to the mesh based on the topology and shape of the original mesh. In some examples, the subdivision process starts by taking the reduced mesh that was generated by the decimation process and iteratively adding new vertices and edges. For example, the subdivision process may comprise dividing each edge (or face) of the reduced/decimated mesh into shorter edges (or smaller faces) and creating new vertices at the points of division. These new vertices are then connected to form new faces (e.g., triangles, quadrilaterals, or another polygon). By applying subdivision after the decimation process, a higher level of compression can be achieved without significant loss of visual fidelity. Various subdivision schemes may be used such as, e.g., mid-point, Catmull-Clark subdivision, Butterfly subdivision, Loop subdivision, etc., or a combination thereof.

For example, FIG. 5 illustrates an example of the mid-point subdivision scheme. In this scheme, each subdivision iteration subdivides each triangle into four sub-triangles. New vertices are introduced in the middle of each edge. The subdivision process may be applied independently to the geometry and to the texture coordinates since the connectivity for the geometry and for the texture coordinates are usually different. The subdivision scheme computes the position Pos(v₁₂) of a newly introduced vertex v₁₂ at the center or middle of an edge (v₁,v₂) formed by a first vertex (v₁) and a second vertex (v₂), as follows:

$$Pos ( {v}_{12} ) = \frac{1}{2} ( Pos ( {v}_{1} ) + Pos ( {v}_{2} ) ) ,$$

where Pos(v₁) and Pos(v₂) are the positions of the vertices v₁ and v₂. In some examples, the same process may be used to compute the texture coordinates of the newly created vertex. For normal vectors, a normalization step may be applied as follows:

$$N ( {v}_{12} ) = \frac{N ( {v}_{1} ) + N ( {v}_{2} )}{‖ N ( {v}_{1} ) + N ( {v}_{2} ) ‖} ,$$

N(v₁₂), N(v₁), and N(v₂) are the normal vectors associated with the vertices v₁₂, v₁, and v₂, respectively. ∥x∥ is the norm2 of the vector x.

Using the mid-point subdivision scheme, as shown in up-sampled surface 530, point 531 may be generated as the mid-point of edge 522 which is an edge connecting point 532 and point 533. Point 531 may be added as a new vertex. Edge 534 and edge 542 are also added to connect the added new vertex corresponding to point 531. In some examples, the original edge 522 may be replaced by two new edges 534 and 542.

In some examples, down-sampled surface 520 may be iteratively subdivided to generate up-sampled surface 530. For example, a first subdivided mesh resulting from a first iteration of subdivision applied to down-sampled surface 520 may be further subdivided according to the subdivision scheme to generate a second subdivided mesh, etc. In some examples, a number of iterations corresponding to levels of subdivision may be predetermined. In other examples, an encoder may indicate the number of iterations to a decoder, which may similarly generate a subdivided mesh, as further described above.

In some embodiments, the subdivided mesh may be deformed towards (e.g., approximates) the original mesh to determine (e.g., get or obtain) a prediction of the original mesh having original surface 510. The points on the subdivided mesh may be moved along a computed normal orientation until it reaches an original surface 510 of the original mesh. The distance between the intersected point on the original surface 510 and the subdivided point may be computed as a displacement (e.g., a displacement vector). For example, point 531 may be moved towards the original surface 510 along a computed normal orientation of surface (e.g., represented by edge 542). When point 531 intersects with surface 514 of the original surface 510 (of original/input mesh), a displacement vector 548 can be computed. Displacement vector 548 applied to point 531 may result in displaced surface 540, which may better approximate original surface 510. In some examples, displacement information (e.g., displacement vector 548) for vertices of the subdivided mesh (e.g., up-sampled surface 530 of subdivided mesh) may be encoded and transmitted in displacement bitstream 260 shown in examples encoders of FIGS. 2A and 2B. Note, as explained with respect to FIG. 4, the subdivided mesh corresponding to up-sampled surface may be subdivided mesh 442 that is compared to deformed mesh 436 representative of original surface 510 of the input mesh.

In some embodiments, displacements d(i) (e.g., a displacement field or displacement vectors) may be computed and/or stored based on local coordinates or global coordinates. For example, a global coordinate system is a system of reference that is used to define the position and orientation of objects or points in a 3D space. It provides a fixed frame of reference that is independent of the objects or points being described. The origin of the global coordinate system may be defined as the point where the three axes intersect. Any point in 3D space can be located by specifying its position relative to the origin along the three axes using Cartesian coordinates (x, y, z). For example, the displacements may be defined in the same cartesian coordinate system as the input or original mesh. Accordingly, a displacement may comprise three components (in the x, y, and z directions).

In a local coordinate system, a normal, a tangent, and/or a binormal vector (which are mutually perpendicular) may be determined that defines a local basis for the 3D space to represent the orientation and position of an object in space relative to a reference frame. In some examples, displacement field d(i) may be transformed from the canonical coordinate system to the local coordinate system, e.g., defined by a normal to the subdivided mesh at each vertex (e.g., commonly referred to as a vertex normal). The normal at each vertex may be obtained from combining the face normals of triangles formed by the vertex. In some examples, using the local coordinate system may enable further compression of tangential components of the displacements compared to the normal component. For example, the displacements may be signaled as a scalar value (e.g., including a sign and a magnitude) which may be used to derive a displacement vector based on the normal at the vertex. Accordingly, using local coordinate system, displacements need not be signaled as three components corresponding to the directions of the canonical coordinate system.

In some embodiments, a decoder (e.g., decoder 300 of FIG. 3) may receive and decode a base mesh corresponding to (e.g., having) down-sampled surface 520. Similar to the encoder, the decoder may apply a subdivision scheme to determine a subdivided mesh having up-sampled surface 530 generated from down-sampled surface 520. The decoder may receive and decode displacement information including displacement vector 548 and determine a decoded mesh (e.g., reconstructed mesh) based on the subdivided mesh (corresponding to up-sampled surface 530) and the decoded displacement information. For example, the decoder may add the displacement at each vertex with a position of the corresponding vertex in the subdivided mesh. The decoder may obtain a reconstructed 3D mesh by combining the obtained/decoded displacements with positions of vertices of the subdivided mesh.

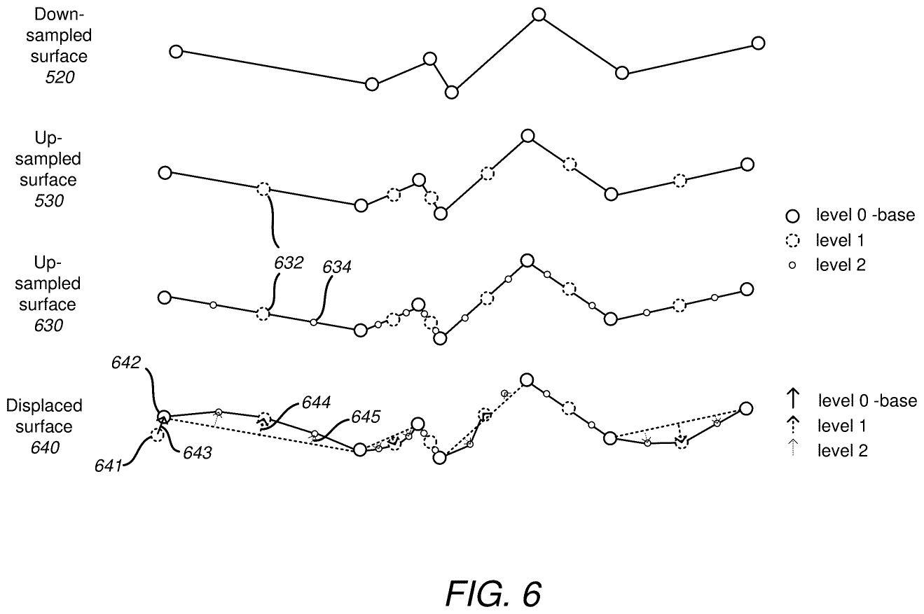

FIG. 6 illustrates an example of vertices of a subdivided mesh (e.g., a subdivided base mesh) corresponding to multiple levels of detail (LODs), according to some embodiments. As described above with respect to FIG. 5, the subdivision process (e.g., subdivision scheme) may be an iterative process, in which a mesh can be subdivided multiple times and a hierarchical data structure is generated containing multiple levels. Each level of the hierarchical data structure may include different numbers of data samples (e.g., vertices and edges in mesh) representing (e.g., forming) different density/resolution (e.g., also referred to as levels of details (LoDs)). For example, a down-sampled surface 520 (of a decimated mesh) can be subdivided into up-sampled surface 530 after a first iteration of subdivision. Up-sampled surface 530 may be further subdivided into up-sampled surface 630 and so forth. In this case, vertices of the mesh with down-sampled surface 520 may be considered as being in or associated with LOD0. Vertices, such as vertex 632, generated in up-sampled surface 530 after a first iteration of subdivision may be at LOD1. Vertices, such as vertex 634, generated in up-sampled surface 630 after another iteration of subdivision may be at LOD2, etc. In some examples, an LOD0 may refer to the vertices resulting from decimation of an input (e.g., original) mesh resulting in a base mesh with (e.g., having) down-sampled surface 520. For example, vertices at LOD0 may be vertices of a reconstructed quantized base mesh 256 of FIGS. 2A-B, reconstructed/decoded base mesh 340 of FIG. 3, reconstructed base mesh 440 of FIG. 4.

In some examples, the computation of displacements in different LODs follows the same mechanism as described above with respect to FIG. 5. In some examples, a displacement vector 643 may be computed from a position of a vertex 641 in the original surface 510 (of original mesh) to a vertex 642, from displace surface 640 of the deformed mesh, at LOD0. The displacement vectors 644 and 645 of corresponding vertices 632 and 634 from LOD1 and LOD 2, respectively, may be similarly calculated. Accordingly, in some examples, a number of iterations of subdivision may correspond to a number of LODs and one of the iterations may correspond to one LOD of the LODs.

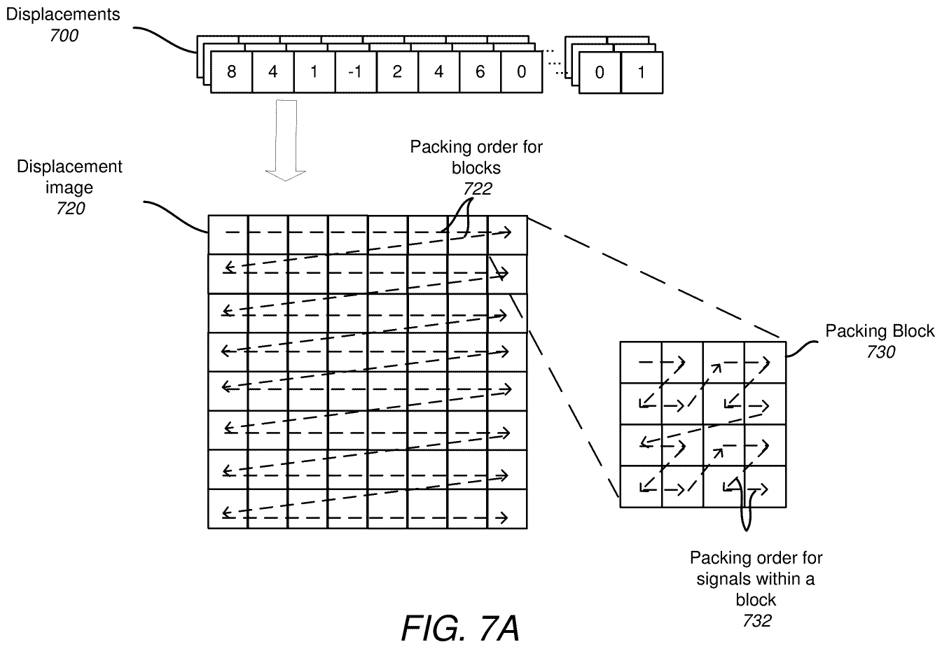

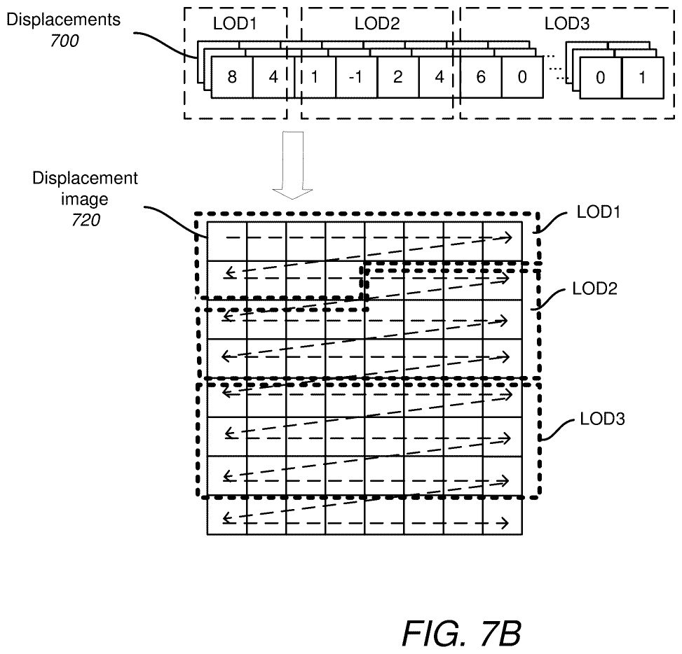

FIG. 7A illustrates an example of an image 720 (e.g., picture or a picture frame) packed with displacements 700 (e.g., displacement fields or vectors) using a packing method (e.g., a packing scheme or a packing algorithm), according to some embodiments. Specifically, displacements 700 may be generated, as described above with respect to FIG. 5 and FIG. 6, and packed into 2D images. In some examples, a displacement can be a 3D vector containing the values for the three components of the distance. For example, a delta x value represents the shift on the x-axis from a point A to a point B in a Cartesian coordinate system. In some examples, a displacement vector may be represented by less than three components, e.g., by one or two components. For example, when a local coordinate system is used to store the displacement value, one component with the highest significance may be stored as being representative of the displacement and the other components may be discarded.

In some examples, as will be further described below, a displacement value may be transformed into other signal domains for achieving better compression. For example, a displacement can be wavelet transformed and be decomposed into and represented as wavelet coefficients (e.g., coefficient values or transform coefficients). In these examples, displacements 700 that are packed in image 720 may comprise the resulting wavelet coefficients (e.g., transform coefficients), which may be more efficiently compressed than the un-transformed displacement values. At the decoder side, a decoder may decode displacements 700 as wavelet coefficients and may apply an inverse wavelet transform process to reconstruct the original displacement values obtained at the encoder.

In some examples, one or more of displacements 700 may be quantized by the encoder before being packed into displacement image 720. In some examples, one or more displacements may be quantized before being wavelet transformed, after being wavelet transformed, or quantized before and after being wavelet transformed. For example, FIG. 7A shows quantized wavelet transform values 8, 4, 1, −1, etc. in displacements 700. At the decoder side, the decoder may perform inverse quantization to reverse or undo the quantization process performed by the encoder.

In general, quantization in signal processing may be the process of mapping input values from a larger set to output values in a smaller set. It is often used in data compression to reduce the amount, the precision, or the resolution of the data into a more compact representation. However, this reduction can lead to a loss of information and introduce compression artifacts. The choice of quantization parameters, such as the number of quantization levels, is a trade-off between the desired level of precision and the resulting data size. There are many different quantization techniques, such as uniform quantization, non-uniform quantization, and adaptive quantization that may be selected/enabled/applied. They can be employed depending on the specific requirements of the application.

In some examples, wavelet coefficients (e.g., displacement coefficients representing displacement signals) may be adaptively quantized according to LODs. As explained above, a mesh may be iteratively subdivided to generate a hierarchical data structure comprising multiple LODs. In this example, each vertex and its associated displacement belong to the same level of hierarchy in the LOD structure, e.g., an LOD corresponding to a subdivision iteration in which that vertex was generated. In some examples, a vertex at each LOD may be quantized according to corresponding quantization parameters that specify different levels of intensity/precision of the signal to be quantized. For example, wavelet coefficients in LOD 3 may have a quantization parameter with, e.g., 42 and wavelet coefficients in LOD 0 may have a different, smaller quantization parameter of 28 to preserve more detail information in LOD 0.

In some examples, displacements 700 may be packed onto the pixels in a displacement image 720 with a width W and a height H. In an example, a size of displacement image 720 (e.g., W multiplied by H) may be greater or equal to the number of components in displacements 700 to ensure all displacement information may be packed. In some examples, displacement image 720 may be further partitioned into smaller regions (e.g., squares) referred to as a packing block 730. In an example, the length of packing block 730 may be an integer multiple of 2.

The displacements 700 (e.g., displacement signals represented by quantized wavelet coefficients) may be packed into a packing block 730 according to a packing order 732. Each packing block 730 may be packed (e.g., arranged or stored) in displacement image 720 according to a packing order 722. Once all the displacements 700 are packed, the empty pixels in image 720 may be padded with neighboring pixel values for improved compression. In the example shown in FIG. 7A, packing order 722 for packing blocks may be a raster order and a packing order 732 for displacements within packing block 730 may be, for example, a Z-order. However, it should be understood that other packing schemes both for blocks and displacements within blocks may be used. In some embodiments, a packing scheme for the blocks and/or within the blocks may be predetermined. In some embodiments, the packing scheme may be signaled by the encoder in the bitstream per patch, patch group, tile, image, or sequence of images. Relatedly, the signaled packing scheme may be obtained by the decoder from the bitstream.

In some examples, packing order 732 may follow a space-filling curve, which specifies a traversal in space in a continuous, non-repeating way. Some examples of space-filling curve algorithms (e.g., schemes) include Z-order curve, Hilbert Curve, Peano Curve, Moore Curve, Sierpinski Curve, Dragon Curve, etc. Space-filling curves have been used in image packing techniques to efficiently store and retrieve images in a way that maximizes storage space and minimizes retrieval time. Space-filling curves are well-suited to this task because they can provide a one-dimensional representation of a two-dimensional image. One common image packing technique that uses space-filling curves is called the Z-order or Morton order. The Z-order curve is constructed by interleaving the binary representations of the x and y coordinates of each pixel in an image. This creates a one-dimensional representation of the image that can be stored in a linear array. To use the Z-order curve for image packing, the image is first divided into small blocks, typically 8×8 or 16×16 pixels in size. Each block is then encoded using the Z-order curve and stored in a linear array. When the image needs to be retrieved, the blocks are decoded using the inverse Z-order curve and reassembled into the original image.

In some examples, once packed, displacement image 720 may be encoded and decoded using a conventional 2D video codec.

FIG. 7B illustrates an example of displacement image 720, according to some embodiments. As shown, displacements 700 packed in displacement image 720 may be ordered according to their LODs. For example, displacement coefficients (e.g., quantized wavelet coefficients) may be ordered from a lowest LOD to a highest LOD. In other words, a wavelet coefficient representing a displacement for a vertex at a first LOD may be packed (e.g., arranged and stored in displacement image 720) according to the first LOD. For example, displacements 700 may be packed from a lowest LOD to a highest LOD. Higher LODs represent a higher density of vertices and corresponds to more displacements compared to lower LODs. The portion of displacement image 720 not in any LOD may be a padded portion.

In some examples, displacements may be packed in inverse order from highest LOD to lowest LOD. In an example, the encoder may signal whether displacements are packed from lowest to highest LOD or from highest to lowest LOD.

In some examples, a wavelet transform may be applied to displacement values to generate wavelet coefficients (e.g., displacement coefficients) representing displacement signals that may be more easily compressed. Wavelet transforms are commonly used in signal processing to decompose a signal into a set of wavelets, which are small wave-like functions allowing them to capture localized features in the signal. The result of the wavelet transform is a set of coefficients that represent the contribution of each wavelet at different scales and positions in the signal. It is useful for detecting and localizing transient features in a signal and is generally used for signal analysis and data compression such as image, video, and audio compression.

Taking a 2D image as an example, a wavelet transform is used to decompose an image (signals) into two discrete components, known as predictions (e.g., also referred to as approximations) and details. The decomposed signals are further divided into a high frequency component (details) and a low frequency component (approximations/predictions) by passing through two filters, high and low pass filters. In the example of the 2D image, two filtering stages, a horizontal and a vertical filtering, are applied to the image signals. A down-sampling step is also required after each filtering stage on the decomposed components to obtain the wavelet coefficients resulting in four sub-signals in each decomposition level. The high frequency component corresponds to rapid changes or sharp transitions in the signal, such as an edge or a line in the image. On the other hand, the low frequency component refers to global characteristics of the signal. Depending on the application, different filtering and compression can be achieved. There are various types of wavelets such as Haar, Daubechies, Symlets, etc., each with different properties such as frequency resolution, time localization, etc.

In signal processing, a lifting scheme is a technique for both designing wavelets and performing the discrete wavelet transform (DWT). It is an alternative approach to the traditional filter bank implementation of the DWT that offers several advantages in terms of computational efficiency and flexibility. It decomposes the signal using a series of lifting steps such that the input signal, e.g., representing displacements for 3D meshes, may be converted to displacement coefficients in-place. In the lifting scheme, a series of lifting operations (e.g. lifting steps) may be performed. Each lifting operation involves a prediction step (e.g., prediction operation) and an update step (e.g., update operation). These lifting operations may be applied iteratively to obtain the wavelet coefficients.

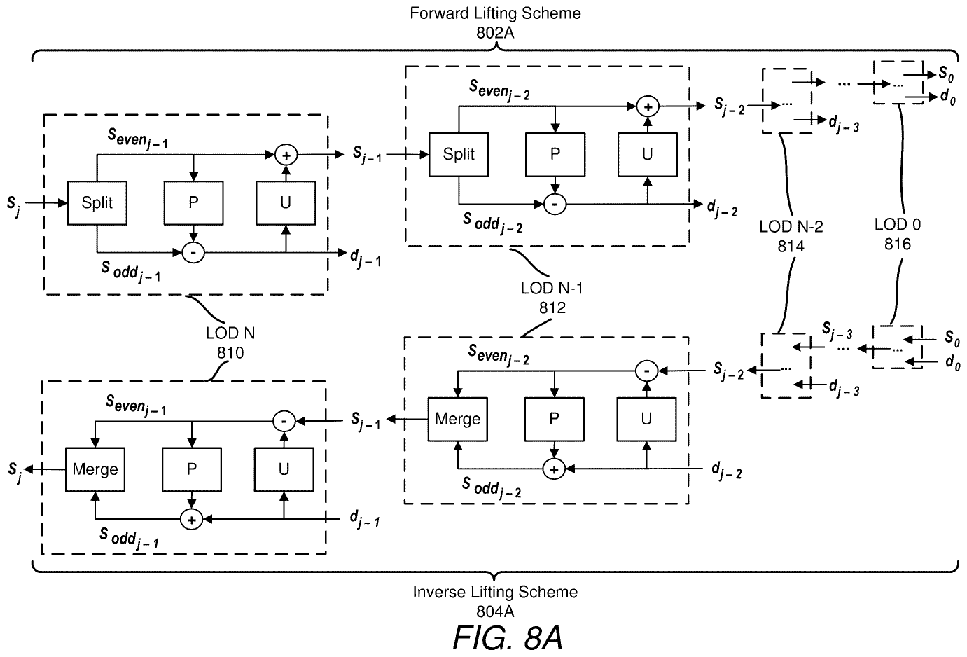

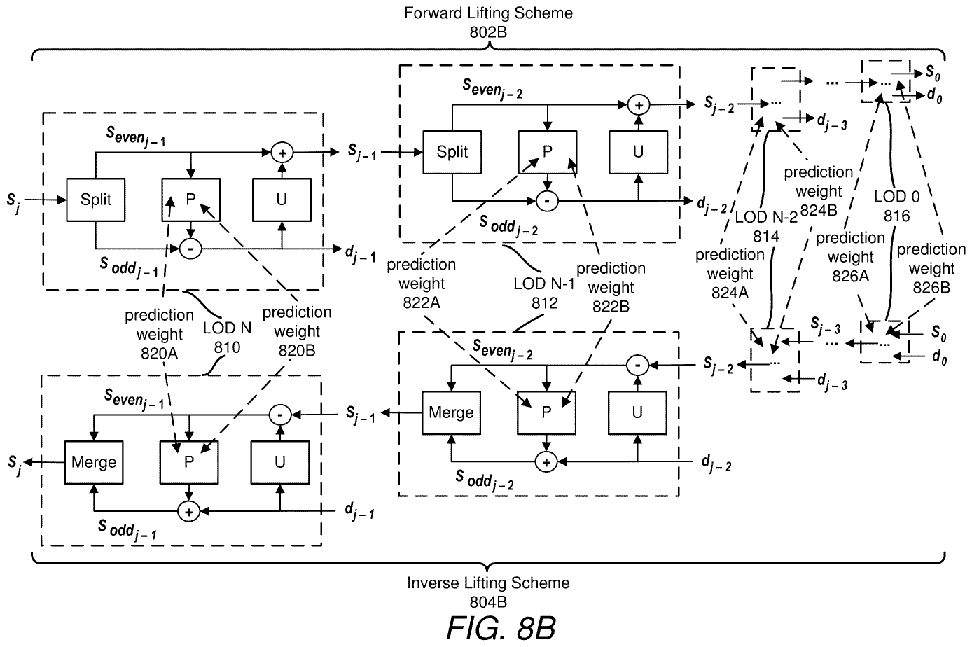

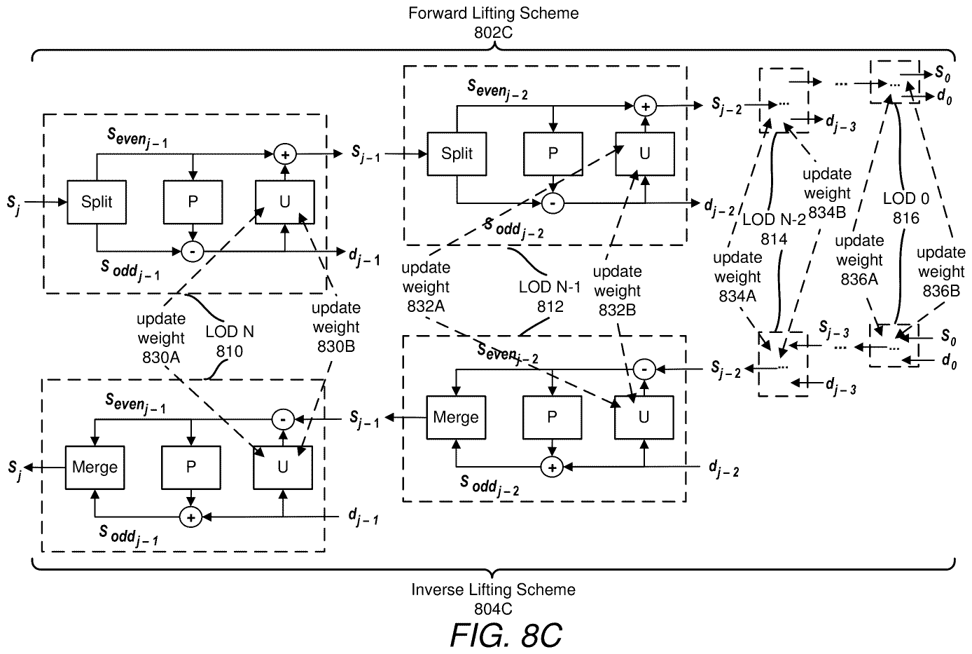

FIG. 8A illustrates an example of a lifting scheme for representing displacement information of a 3D mesh as wavelet coefficients, according to some embodiments. The lifting scheme may refer to a forward lifting scheme 802A and/or an inverse lifting scheme 804A. The lifting scheme comprises a plurality of lifting operations, which may be iteratively performed. Each lifting operation may include a prediction operation (e.g., prediction step) and an update operation (e.g., an update step). An encoder may perform (e.g., apply) forward lifting scheme 802A to determine (e.g., derive, generate, or obtain) wavelet coefficients representing displacement information. A decoder may perform (e.g., apply) inverse lifting scheme 804A to reverse the operations of forward lifting scheme 802A to determine (e.g., derive, generate, or obtain) the displacement information from wavelet coefficients decoded from a bitstream. The decoded displacement information may include displacement values (e.g., displacement vectors) corresponding to vertices of a 3D mesh frame, which may be used by the decoder to generate a decoded mesh (e.g., a reconstructed mesh).

Forward lifting scheme 802A comprises a plurality of iterations corresponding to a plurality of LODs, e.g., shown as LOD_{N} 810, LOD_{N-1} 812, LOD_{N-2} 814, and LOD₀ 816. As explained above, each LOD may correspond to an iteration of subdivision. For example, vertices at an LOD are determined based on applying an iteration of a subdivision scheme. Each iteration of forward lifting scheme 802A (e.g., four iterations are shown as four dotted boxes corresponding to LODs 810-816) includes a splitting operation (e.g., a splitting step shown as a “Split” component), a prediction operation (e.g., a prediction step shown as a “P” component), and an update operation (e.g., an update step shown as a “U” component).

The splitting operation separates (or splits) signal sⱼ (j≥1) into two non-overlapping signals: the even samples denoted by sₑᵥₑₙ_{ₖ} (k∈[0, j−1]) and the odd samples denoted by s_{odd}_{ₖ}. Signal sⱼ represents the displacement values (e.g., displacement signals) determined for vertices of the 3D mesh frame. For example, a displacement value comprises a displacement field (e.g., a displacement vector), which may be one, two, or three components, as explained above. In each lifting operation iteration, the odd samples s_{odd}_{ₖ} include the displacement coefficients of vertices at an LOD corresponding to the iteration. For each odd sample of the odd samples s_{odd}_{ₖ}, the even samples sₑᵥₑₙ_{ₖ} may include the two displacement coefficients of the two vertices, of the 3D mesh frame, from which the vertex corresponding to the odd sample was generated during a mesh subdivision or down-sampling process, as explained above with respect to FIG. 6. Since vertices at the LOD are generated from vertices at lower LODs, the two vertices of the 3D mesh frame are at LODs that are lower than the LOD of the lifting operation iteration.

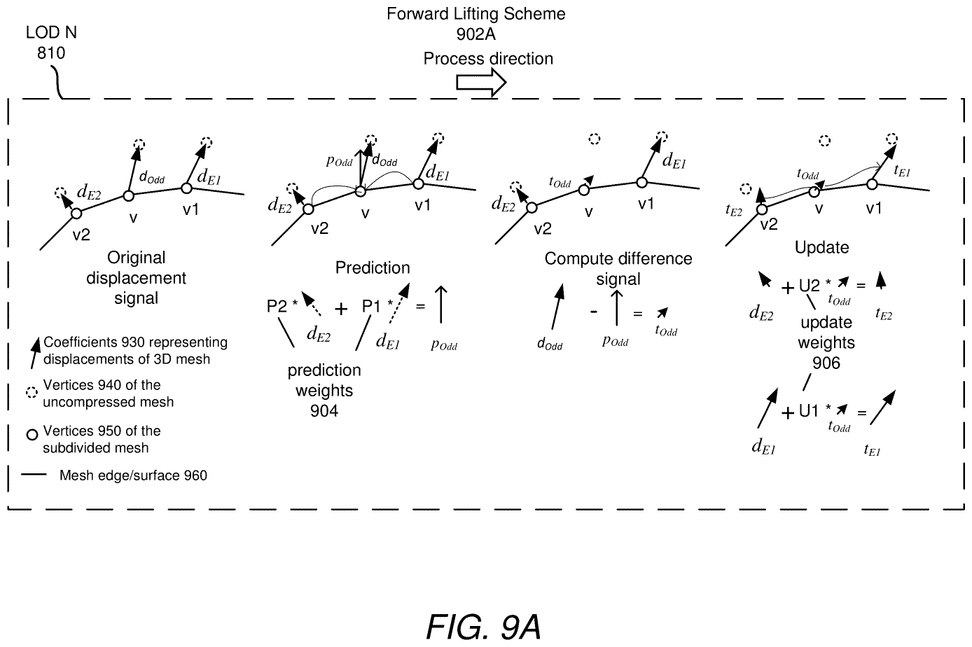

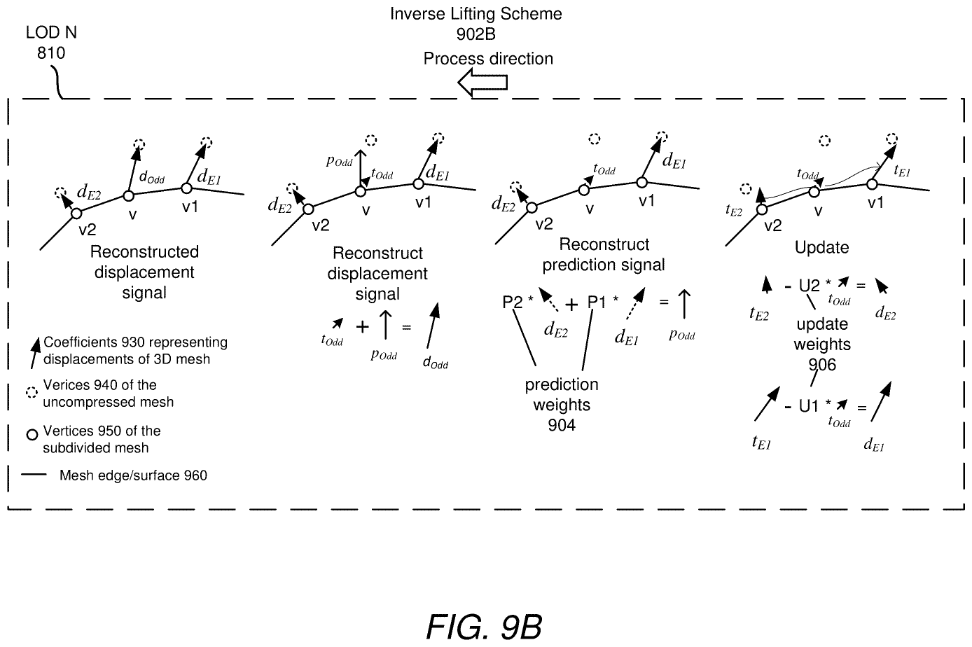

The prediction operation determines (e.g., computes) a prediction for the odd samples based on the even samples. For example, the prediction may be subtracted from the odd samples (e.g., shown as circles with negative signs) to generate a prediction error, e.g., error signal dₖ (k∈[0, j−1]). Forward lifting scheme 802A also includes an update operation that recalibrates the low-frequency signals (e.g., corresponding to signals at lower LODs) with some of the energy removed during the subsampling. In the case of classical lifting, this is used to prepare the even signals for the next prediction operation in the next iteration of forward lifting scheme 802A. For example, the update operation updates (e.g., prepares) the even signals based on the error signal dₖ representing a difference between odd sample s_{odd}_{ₖ} and a corresponding predicted odd sample. In some examples, the update operation may update the even signal sₑᵥₑₙ_{ₖ} based on adding the prediction error dₖ to the even signal sₑᵥₑₙ_{ₖ} (e.g., shown as circle with positive signs). In some examples, the prediction error dₖ may be adjusted by an update weight, as will be further described below in FIGS. 9A-B and 10A-B, and the even signal may be updated based on the adjusted prediction error.

In some embodiments, a decoder performs inverse lifting scheme 804A to reverse the operations of forward lifting scheme 802A. For example, whereas forward lifting scheme 802A comprises lifting operations that are iteratively performed from higher LODs (e.g., LOD_{N} 810) to lower LODs (e.g., LOD₀ 816), inverse lifting scheme 804A comprises lifting operations that are iteratively performed from lower LODs (e.g., LOD₀ 816) to higher LODs (e.g., LOD_{N} 810). Each iteration of inverse lifting scheme 804A (e.g., four iterations are shown as four dotted boxes corresponding to LODs 810-816) includes an update operation (e.g., an update step shown as a “U” component), a prediction operation (e.g., a prediction step shown as a “P” component), and a merge operation (e.g., a merge step shown as a “Merge” component).

Different from forward lifting scheme 802A, an update operation, in each lifting operation of inverse lifting scheme 804A, may update the even signals sₖ (e.g., corresponding to transformed displacement coefficients) by subtracting prediction error dₖ (corresponding to odd signals at the LOD corresponding to the lifting operation iteration) from the even samples to determine the updated even samples sₑᵥₑₙ_{ₖ}. In some examples, the prediction error dₖ may be adjusted by an update weight and the even samples may be updated based on the adjusted prediction error. In some examples, the update operation may be performed according to an update scheme. As will be further explained below, the update scheme may be one of various schemes such as a default update (e.g., with constant weight), an LOD-based update, a valence-based update, a similarity-based prediction, a normal-based update, or a combination thereof etc.

A prediction operation, in each lifting operation of inverse lifting scheme 804A, may determine a reconstructed predicted odd sample s_{odd}_{ₖ} based on the updated even samples sₑᵥₑₙ_{ₖ}. In some examples, the prediction operation may be performed according to a prediction scheme. As will be further explained below, the prediction scheme may be one of various schemes such as an average prediction, a similarity-based prediction, a normal-based prediction, or a combination thereof etc. For example, the prediction operation may be performed using an average prediction scheme, in which an average of two updated even samples sₑᵥₑₙ_{ₖ} is determined to generate a prediction of a reconstructed odd sample.

Each lifting operation of inverse lifting scheme 804A combines or sums (e.g., shown as circles with positive signs) the reconstructed predicted odd sample with the prediction error dₖ to determine (e.g., generate or obtain) a displacement signal s_{odd}_{ₖ} corresponding to a displacement value determined at the encoder. In other words, the plurality of iterations of inverse lifting scheme 804A converts the wavelet coefficients (displacement coefficients), generated by the encoder and representing displacement information, into displacement values that may be used to reconstruct the (3D) mesh frame. Further, to revert the splitting operation of forward lifting scheme 802A, each lifting operation of inverse lifting scheme 804A includes a merge operation that merges (e.g., orders or combines as a sequence of signals or values) the updated even samples sₑᵥₑₙ_{ₖ} with the reconstructed odd sample s_{odd}_{ₖ}.

Note that the value j in FIG. 8A corresponds to a number of iterations for the lifting operations which varies depending on the specific requirement of the application for 3D meshes. For example, the number of levels in LOD defined by the mesh decimation process may be used for the lifting operations. In some examples, a mid-point subdivision scheme may be used in the mesh decimation process. In these examples, since each vertex in a higher LOD level is a generated mid-point of an edge defined by two vertices in lower LOD levels, the signal (e.g., displacement value or its wavelet coefficient representation) associated with that vertex may be decomposed and represented by two sub-signals (e.g., displacement values or their wavelet coefficient representations) which belong to the corresponding two vertices. For example, a vertex v in LOD₁ (e.g., an LOD of level 1) may be the mid-point of the edge defined by two vertices v1 and v2 in LOD₀ (e.g., an LOD of level 0). In this example, the displacement associated with v can be wavelet transformed by using the lifting scheme. For an odd signal s_{odd}_{ₖ} corresponding to vertex v (e.g., the signal being the displacement signal or its wavelet coefficient representation), the even samples sₑᵥₑₙ_{ₖ} determined for odd signal s_{odd}_{ₖ} may correspond to vertices v1 and v2 (e.g., the signals being displacement signals or their wavelet coefficient representations) from which vertex v was generated.

In the lifting scheme, prediction weight and update weight are the values used to modify the input data during the prediction and update steps, respectively. The prediction weight may be a scalar value or a set of coefficients that define the linear combination of the neighboring signals used for prediction while the update weight determines the contribution of the prediction error to the final updated value. For example, the prediction may be determined from two input even samples using an average prediction scheme in which a prediction weight is equal to one half, which effectively averages signal values of the two input even samples. The prediction and update weights are often selected to satisfy certain properties or conditions to achieve desired characteristics in the transformed data. For example, in lossless lifting schemes, the weights may be designed to ensure perfect reconstruction of the original signal. In lossy lifting schemes, the weights may be selected to achieve specific frequency response characteristics or to minimize distortion based on the compression or denoising requirements.

In some implementations of the lifting scheme, the prediction weight and the update weight may be determined (e.g., selected), applied to displacements for vertices of a 3D mesh (e.g., each mesh frame of a sequence of mesh frames), such as to balance accuracy and properties resulting from the wavelet transforms corresponding to the displacements. As explained above, prediction operations of each iteration of the inverse lifting scheme may be dependent on (e.g., impacted by) updated signals inputs to the prediction operation. In the default update scheme, the update weight may be a value (e.g., ⅛, ¼, or 1/16, etc.) selected to be uniformly applied to wavelet coefficients corresponding (e.g., representing) the displacements. Due to characteristics and geometry of the mesh frame, characteristics at each LOD may not be the same. Therefore, applying the same update weight may results in reduced compression for displacements (e.g., displacement signals) for vertices at certain LODs.

In some embodiments, adaptive update weights in the lifting scheme are applied to displacements for vertices of 3D meshes (e.g., mesh frames of a sequence of mesh frames of a 3D mesh). For example, instead of the default update scheme, an LOD-based update scheme may be used to generate update weights for the forward and inverse lifting transforms. In the LOD-based update scheme, an update weight for each wavelet coefficient may be determined based on an LOD associated with that wavelet coefficient. As explained above, the lifting scheme may include a plurality of lifting operations corresponding to a plurality of LODs in the 3D mesh (e.g., mesh frame). For a forward lifting scheme, each iteration of the lifting operation may update (e.g., lift) a sequence of displacement signals (e.g., displacement values or corresponding wavelet coefficients representing the displacement values) from a higher LOD (e.g., denser vertices) to one or more lower LODs (e.g., sparser vertices) and accumulate the prediction towards vertices at the lowest LOD (e.g., vertices of the base mesh). Similarly, for an inverse lifting scheme, each iteration of the lifting operation may update (e.g., lift) a sequence of displacement signals (e.g., displacement values or corresponding wavelet coefficients representing the displacement values) from lower LOD (e.g., sparser vertices) to higher LODs (e.g., denser vertices). Since the update weight determines the amount of contribution of the prediction error to the final updated value, adapting uniform weight values to consider the impact of different LOD levels may result in more accurate predicting signals across different LOD levels. In some examples, lower LODs may be associated with smaller update weights and higher LODs may be associated with larger update weights. In some examples, lower LODs may be associated with larger update weights and higher LODs may be associated with smaller update weights.

FIG. 8B illustrates an example of a lifting scheme, for representing displacement information of a 3D mesh as wavelet coefficients, in which prediction weights 820-826 may be separately and adaptively determined (e.g., set or adjusted) for displacement signals on which the prediction weights are applied, according to some embodiments. As explained above, in each lifting operation, a pair of coefficients (even samples/coefficients), associated with a coefficient (odd sample/coefficient), may be obtained to predict the coefficient. Different from FIG. 8A, prediction weights 820-826 may be adaptively determined (e.g., set or adjusted) for each forward/inverse lifting transform operation. Specifically, instead of using an average prediction scheme in which each prediction weight for the even signals is 0.5, a separate prediction weight may be determined for each even signal of a pair of even signals used to generate a predictor for the odd signal. As shown by the A and B labels for each of prediction weights 820-826, each coefficients in the pair may have an associated prediction weight A for the first coefficient and prediction weight B for the second coefficient. The lifting scheme may be performed iteratively for vertices in each LOD of LODs 810-816, according to some embodiments.

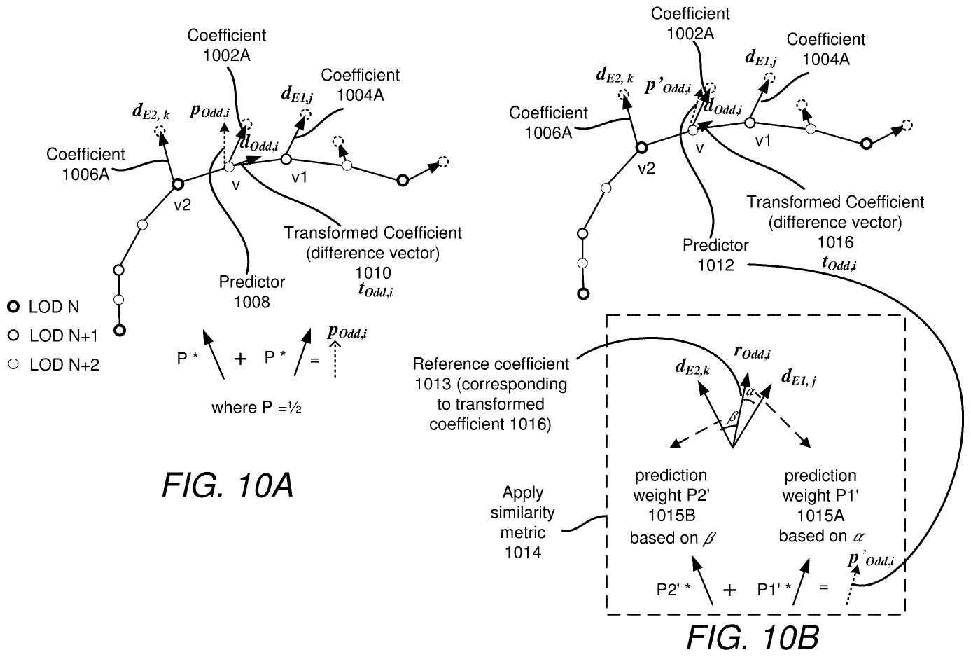

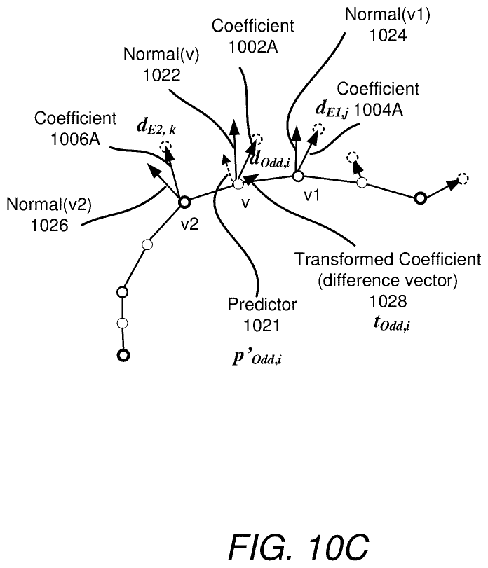

In some embodiments, various adaptive prediction schemes may be used. For example, a similarity-based prediction scheme may be used that generates the predictor based on similarities between the even signals and the odd signal on which the even signals are used to predict, as explained below in FIG. 10B. In this case, each coefficient in the pair may have an associated prediction weight A for the first coefficient and prediction weight B for the second coefficient determined depending on similarities determined for the first and second coefficients, e.g., with respect to a reference coefficient corresponding to the coefficient.

The adaptive prediction scheme may refer to forward lifting scheme 802B (e.g., performed by an encoder or wavelet transformer 210 of FIG. 2A and/or FIG. 2B) and/or inverse lifting scheme 804B (e.g., performed by a decoder or inverse wavelet transformer 314 of FIG. 3), which enhances forward lifting scheme 802A and inverse lifting scheme 804A, respectively. Similarly, forward lifting scheme 802B and inverse lifting scheme 804B comprise a plurality of lifting operations that correspond to LODs 810-816. In forward lifting scheme 802B, the lifting operations are iteratively applied (e.g., performed) to displacement signals of vertices from higher LODs to lower LODs. In inverse lifting scheme 804B, the lifting operations are iteratively applied (e.g., performed) to displacement signals of vertices from lower LODs to higher LODs.

In some embodiments, a first prediction indication (e.g., a mode indication, a flag, or a syntax element) may be signaled by the encoder in the bitstream and/or obtained by the decoder from the bitstream. The first prediction indication indicates whether adaptive prediction weights are enabled (e.g., to be applied) in the lifting scheme (e.g., in inverse lifting scheme 804B). If the first prediction indication indicates that adaptive prediction weights are disabled (e.g., not enabled or not applied), the same prediction weight may be used in lifting operations as in FIG. 8A. In this example, each of prediction weights 820-826 may have the same value, e.g., 0.5. In some examples, the encoder may determine the first indication to be signaled based on whether using uniform prediction weights (e.g., the first indication disabling adaptive update weights) or adaptive prediction weights (e.g., the first indication enabling adaptive update weights) results in higher compression performance (e.g., resulting in less bits in displacement bitstream 260 of FIG. 2A and/or FIG. 2B or based on a lower rate-distortion optimization (RDO) cost). The decoder may obtain (e.g., decode) the first prediction indication from the bitstream and determine whether inverse lifting scheme 804B applies adaptive prediction weights based on the first indication. In some examples, the first prediction indication may be signaled per subset of vertices. For example, the subset of vertices may be associated with a sequence of 3D meshes, a 3D mesh frame, a sub-mesh, a patch, a tile, a patch group, an LOD, etc.

In some embodiments, the first prediction indication may be a binary value for enabling or disabling adaptive prediction weights.

In some embodiments, the first prediction indication is omitted from the bitstream and the adaptive prediction weights are enabled by default.

In some examples, the first prediction indication may specific whether an adaptive prediction scheme such as the similarity-based prediction is enabled.

In some embodiments, instead of the first prediction indication, an indication (e.g., a mode indication, a flag, or a syntax element) of a prediction scheme may be signaled by the encoder in the bitstream and/or obtained by the decoder from the bitstream. For example, the indication of the prediction scheme may indicate a prediction scheme from a plurality of prediction schemes. For example, the prediction scheme indication may be an index to a list/table of the prediction schemes. In some examples, the plurality of prediction schemes may include a default prediction scheme (e.g., an average prediction scheme), a normal-based prediction scheme, a similarity-based prediction scheme, etc.

In some embodiments, a second prediction indication (e.g., a flag, or a syntax element) may be signaled by the encoder in the bitstream and/or obtained by the decoder from the bitstream. The second prediction indication indicates a prediction mode, associated with an indicated prediction scheme, for determining the adaptive prediction weights. For example, the second indication may indicate a first mode (e.g., mode 0) or a second mode (e.g., mode 1).

For example, when the prediction scheme is the similarity-based prediction scheme, in the first mode, for a first and a second coefficient obtained for predicting a coefficient, the coefficient of the first and second coefficients that is more similar to a reference coefficient, corresponding to the predicted coefficient, may be associated with a higher prediction weight. In the second mode, for the first and the second coefficient obtained for predicting the coefficient, the coefficient of the first and second coefficients that is less similar to the reference coefficient may be associated with a higher prediction weight.

In some examples, the second indication may be signaled per subset of vertices. For example, the subset of vertices may be associated with a sequence of 3D meshes, a 3D mesh frame, a sub-mesh, a patch, a tile, a patch group, an LOD, etc.

In some examples, the first prediction indication may be signaled/obtained and if the first prediction indication indicates adaptive prediction weights are enabled or indicates an adaptive prediction scheme that is not the average prediction scheme, the second prediction indication may be signaled/obtained into/from the bitstream.

In some embodiments, a third prediction indication (e.g., a flag, or a syntax element) may be signaled in the bitstream by the encoder and/or obtained from the bitstream by the decoder. The third prediction indication indicates one or more parameters used in determining (e.g., deriving or computing) the prediction weights. For example, the third prediction indication may indicate an index to a set of scaling factors to specify one of the scaling factors. For example, the third prediction indication may include indication of a numerator and a denominator of a fraction representing a scaling factor used to adjust a prediction weight. For example, the third prediction indication may indicate an offset value or an absolute value of the scaling factor. For example, the third indication may indicate a log 2 value or a power of two, etc.

In some examples, the third prediction indication may be signaled per subset of vertices. For example, the subset of vertices may be associated with a sequence of 3D meshes, a 3D mesh frame, a sub-mesh, a patch, a tile, a patch group, an LOD, etc.

In some examples, the first prediction indication may be signaled/obtained and if the first prediction indication indicates adaptive prediction weights are enabled, the third prediction indication may be signaled/obtained into/from the bitstream.

FIG. 8C illustrates an example of a lifting scheme, for representing displacement information of a 3D mesh as wavelet coefficients, in which update weights 830-836 may be separately and adaptively determined (e.g., set or adjusted) for even signals on which the update weights are applied, according to some embodiments. As explained above, in each lifting operation, a pair of coefficients (even samples/coefficients), associated with a coefficient (odd sample/coefficient), may be obtained to predict the coefficient (e.g., generate a predictor of the coefficient).

In forward lifting scheme 802C, each of the even coefficients are updated based on the coefficient, e.g., based on a difference between the coefficient (s_{odd}) and the predictor. For example, an even coefficient is updated based on adding the difference scaled according to an update weight.

In inverse lifting scheme 804C, each of the even coefficients are obtained and updated based on the transformed coefficient (e.g., d) before the pair of updated even coefficients are used to generate the predictor of the odd coefficient. For example, an even coefficient is updated based on subtracting the transformed coefficient (e.g., d) scaled according to an update weight.

Different from FIG. 8A, update weights 830-836 may be adaptively determined (e.g., set or adjusted) for each forward/inverse lifting transform operation. Specifically, instead of using a default/constant/uniform update scheme in which each update weight for the even signals is the same, a separate update weight may be determined for each even signal of a pair of even signals used to generate a predictor for the odd signal. As shown by the A and B labels for each of prediction weights 820-826, each coefficients in the pair may have an associated update weight A for the first coefficient and update weight B for the second coefficient. The lifting scheme may be performed iteratively for vertices in each LOD of LODs 810-816, according to some embodiments.

In some embodiments, various adaptive update schemes may be used. For example, a similarity-based update scheme may be used that generates the update weights based on similarities between the even signals and the odd signal on which the even signals are used to predict, as explained below in FIG. 10C. In this case, each coefficient in the pair may have an associated update weight A for the first coefficient and update weight B for the second coefficient determined depending on similarities determined for the first and second coefficients, e.g., with respect to a reference coefficient corresponding to the coefficient.

Similar indications (e.g., the first, second, and third indications described above with respect to FIG. 8B) described above for the adaptive prediction scheme may be used for the adaptive update scheme. For example, a first update indication (e.g., a mode indication, a flag, or a syntax element) may be signaled by the encoder in the bitstream and/or obtained by the decoder from the bitstream to indicate whether adaptive update weights are enabled (e.g., to be applied) in the lifting scheme (e.g., in inverse lifting scheme 804B). In some examples, the first update indication may be signaled per subset of vertices. For example, the subset of vertices may be associated with a sequence of 3D meshes, a 3D mesh frame, a sub-mesh, a patch, a tile, a patch group, an LOD, etc.

In some embodiments, instead of the first update indication, an indication (e.g., a mode indication, a flag, or a syntax element) of an update scheme may be signaled by the encoder in the bitstream and/or obtained by the decoder from the bitstream. For example, the indication of the update scheme may indicate an update scheme from a plurality of update schemes. For example, the update scheme indication may be an index to a list/table of the update schemes. In some examples, the plurality of update schemes may include a default update scheme (e.g., uniform/constant scheme), an LOD-based update scheme, a normal-based update scheme, a similarity-based update scheme, etc.

In some embodiments, a second update indication (e.g., a flag, or a syntax element) may be signaled by the encoder in the bitstream and/or obtained by the decoder from the bitstream. The second update indication indicates an update mode, associated with an indicated update scheme, for determining the adaptive update weights. For example, the second update indication may indicate a first mode (e.g., mode 0) or a second mode (e.g., mode 1). For example, when the update scheme is the similarity-based update scheme, in the first mode, for a first and a second coefficient obtained for predicting a coefficient, the coefficient of the first and second coefficients that is more similar to a reference coefficient, corresponding to the predicted coefficient, may be associated with a higher update weight. In the second mode, for the first and the second coefficient obtained for predicting the coefficient, the coefficient of the first and second coefficients that is less similar to the reference coefficient may be associated with a higher update weight. In some examples, the second update indication may be signaled per subset of vertices. For example, the subset of vertices may be associated with a sequence of 3D meshes, a 3D mesh frame, a sub-mesh, a patch, a tile, a patch group, an LOD, etc.

In some embodiments, a third update indication (e.g., a flag, or a syntax element) may be signaled in the bitstream by the encoder and/or obtained from the bitstream by the decoder. The third update indication indicates one or more parameters used in determining (e.g., deriving or computing) the update weights. For example, the third indication may indicate an index to a set of scaling factors to specify one of the scaling factors. For example, the third indication may include indication of a numerator and a denominator of a fraction representing a scaling factor used to adjust an update weight. For example, the third update indication may indicate an offset value or an absolute value of the scaling factor. For example, the third update indication may indicate a log 2 value or a power of two, etc. In some examples, the third update indication may be signaled per subset of vertices. For example, the subset of vertices may be associated with a sequence of 3D meshes, a 3D mesh frame, a sub-mesh, a patch, a tile, a patch group, an LOD, etc.

In some embodiments, the lifting scheme may include a prediction scheme that may be one of a plurality of prediction scheme (e.g., a uniform prediction scheme or an adaptive prediction scheme as described in FIG. 8B) and an adaptive update scheme that may be one of a plurality of update scheme (e.g., a uniform update scheme or an adaptive update scheme as described in FIG. 8C).

FIG. 9A illustrates an example of a forward lifting scheme 902A applied to coefficients at an LOD_{N} 810, according to some embodiments. The encoder may perform forward lifting scheme 902A to generate transformed coefficients, from coefficients representing displacements of a 3D mesh, for encoding in a bitstream. FIG. 9A shows coefficients 930 representing displacements of a 3D mesh, e.g., a 3D mesh frame, vertices 940 of the uncompressed mesh (e.g., corresponding to the subdivided mesh fitted to deformed mesh 436 of FIG. 4), vertices 950 of the subdivided mesh (e.g., subdivided mesh 442, up-sampled surface 530, or up-sampled surface 640), and mesh edge/surface 960 (e.g., surface of the subdivided mesh). As shown, coefficients 930 may be represented by vectors, e.g., 3D vectors each having three components (x,y,z) indicating displacements along the three coordinate axes. In some examples, the three coordinate axes are common with respect to the 3D mesh frame. In some examples, the three coordinate axes are relative to a mesh surface at each vertex corresponding to the coefficient.

For a coefficient (d_{odd}) of a vertex v, a first coefficient (d_{E1}) of a first vertex v1 and a second coefficient (d_{E2}) of a second vertex v2 may be obtained. The coefficient (d_{odd}) may correspond to an original displacement “odd” signal that is to be predicted from the two “even” signals corresponding to the first and second coefficients, as shown in FIG. 8A. In some examples, the first and second vertices (v1 and v2) are determined to be associated with the vertex v based on the first and second vertices being used to generate the vertex v. For example, an edge associated with the vertex v may be obtained from a plurality of edges. The edge may be represented as indications (e.g., indices) of the first and second vertices.

A predictor (p_{odd}) of the coefficient (d_{odd}) may be determined as a combination (e.g., a linear combination) of the first and second coefficients (d_{E1} and d_{E2}) having (e.g., associated with) corresponding prediction weights 904 (P1 and P2). For example, when a prediction scheme is an average prediction, each of the first and second coefficients may be scaled (e.g., weighted) by the same prediction weight P. In this example, the linear combination is a mid-point average, in which case P, P1, and P2 are each 0.5. In some examples, the coefficient may be transformed (e.g., resulting in transformed coefficient t_{odd}) based on a difference between the coefficient and the predictor.

In some examples, the first and second coefficients of the first and second vertices may be updated based on respective weights (U1 and U2) and the transformed coefficient (e.g., the prediction difference indicated as t_{odd}). For example, an updated/transformed first coefficient (t_{E1}) may be determined based on adding the first coefficient (d_{E1}) to the transformed coefficient scaled by an update weight (U1), which may be one of update weights 906. For example, an updated/transformed second coefficient (t_{E2}) may be determined based on adding the second coefficient (d_{E2}) to the prediction scaled by an update weight (U2), which may be one of update weights 906.

In some examples, for example, when the update scheme is a default/uniform update scheme, the update weights 906 including update weights U1 and U2 may be the same across all coefficients.

In some examples, when the update scheme is an LOD-based update scheme, the update weights 906 determined for each of the first and second coefficients may be determined based on an LOD of the vertex v.

In some examples, when the update scheme is an LOD-based update scheme with adaptive update, the update weights 906 including a first and a second update weight (U1 and U2) may be determined according to respective LODs of the first and second vertices corresponding to the first and second update weights U1 and U2, respectively. In these examples, the update weights U1 and U2 may be different if a first LOD of the first vertex v1 is different from a second LOD of the second vertex v2.

As shown in FIG. 9A, after one iteration of forward lifting scheme 902A, the coefficient (d_{odd}) has been transformed to become a transformed coefficient (t_{odd}) that is smaller, which results in less data being encoded in the bitstream.

FIG. 9B illustrates an example of an inverse lifting scheme 902B applied to coefficients at an LOD_{N} 810, according to some embodiments. For example, inverse lifting scheme 902B may reverse operations of forward lifting scheme 902A. The decoder may perform inverse lifting scheme 902B to generate inverse transformed coefficients from coefficients representing displacements of a 3D mesh and obtained from a bitstream. FIG. 9B similarly shows coefficients 930, vertices 940, vertices 950, and mesh edge/surface 960.

For a coefficient (t_{odd}) of a vertex v, a first coefficient (t_{E1}) of a first vertex v1 and a second coefficient (t_{E2}) of a second vertex v2 may be obtained. The coefficient (t_{odd}) (e.g., “odd” signal) may correspond to a transformed coefficient (e.g., obtained from a bitstream) that is to be inverse transformed (e.g., reconstructed) based on a prediction determined from the two “even” signals corresponding to the first and second coefficients, as shown in FIG. 8A. In some examples, the first and second vertices (v1 and v2) are determined to be associated with the vertex v based on the first and second vertices being used to generate the vertex v. For example, an edge associated with the vertex v may be obtained from a plurality of edges. The edge may be represented as indications (e.g., indices) of the first and second vertices. It should be noted each of the first and second coefficients may either be a transformed coefficient obtained from the bitstream or an inverse-transformed coefficient resulting from a previous iteration of inverse lifting scheme 902B.

In some examples, the first and second coefficients (t_{E1} and t_{E2}) of the first and second vertices may be updated based on respective weights 906 (U1 and U2) and the coefficient (t_{odd}). For example, an updated first coefficient (d_{E1}) may be determined based on subtracting the coefficient (t_{odd}), scaled by an update weight U1, from the first coefficient (1:1). Similarly, an updated second coefficient (d_{E2}) may be determined based on subtracting the coefficient (t_{odd}), scaled by an update weight U2, from the second coefficient (t_{E2}).

In some examples, the update weights 906 (U1 and U2) may be the same update weight, as explained with respect to FIG. 9A, when the update scheme is a default/uniform update scheme. In some examples, the update weights 906 (U1 and U2) may have different values, depending on the update scheme, as explained with respect to FIG. 9A.

A predictor (p_{odd}) associated with the coefficient (t_{odd}) may be generated based on a linear combination of the updated first and second coefficients (d_{E1} and d_{E2}) having respective prediction weights 904 (P1 and P2). In some examples, the prediction weights 904 (U1 and U2) may be the same value such as 0.5, as explained in FIG. 9A, when the prediction scheme is an average prediction scheme. In some examples, the prediction weights 904 (U1 and U2) may be adaptive to the first and second vertices V1 and V2 (e.g., based on corresponding LODs) and/or update first and second coefficients at the first and second vertices, respectively, depending on the adaptive prediction scheme being applied.

As shown and explained with respect to FIG. 9A, the predictor (p_{odd}) may be a prediction of inverse transformed coefficient d_{odd}.

In some examples, the coefficient (t_{odd}) may be inverse transformed (resulting in inverse transformed coefficient d_{odd}) based on the coefficient (t_{odd}) and the predictor (p_{odd}). For example, the inverse transformed coefficient may be determined as the sum of the coefficient and the predictor. After completing (e.g., applying) the iterations of inverse lifting scheme 902B from lower LODs to higher LODs, the final/resulting inverse-transformed coefficient (d_{odd}) of the vertex v, which may have been inverse transformed multiple times, may represent a reconstructed displacement coefficient (e.g., reconstructed residual coefficient). In some examples, the number of iterations may be associated with the number of LODs. For example, the number of iterations may be equal to the number of LODs minus one. Vertices 940 of the uncompressed/reconstructed 3D mesh may be determined by adding the reconstructed displacement coefficients to the vertices 950 of the subdivided mesh.

In some implementations, a lifting wavelet transform scheme may be applied to compress displacement signals of vertices of a 3D mesh. Generally, as explained above with respect to FIGS. 8A and FIGS. 9A-B, the lifting scheme includes a “split”/“merge”, “predict”, and “update” operations. In the split operation, an input displacement signal is divided into two groups, e.g., referred to as “odd” and “even” samples corresponding to odd and even coefficients. The predict operation serves as a high-pass filter, by predicting the odd coefficients from the even coefficients. The update operation is used to update the even coefficients so that the next iteration of prediction of the odd coefficient is more accurate. Finally, the odd coefficient is replaced as the difference between the original odd coefficient and its predictor, which is usually a smaller value.

As explained with respect to FIGS. 9A-B, the prediction operation may be an average prediction, in which a mid-point average (e.g., using a uniform prediction weight) is applied to a pair of even coefficients to determine a predictor of an odd coefficient. However, the even coefficients used to predict the odd coefficient may be very dissimilar to the odd coefficient. For example, the vectors representing the even coefficients may have very different directions than a direction of a vector representing the odd coefficient. In such cases, the predictor generated from a mid-point average of the even coefficients may be very inaccurate and results in larger differences between the predictor and the odd coefficient. Since the coefficients are compressed based on its predictors, inaccurate predictions leads to higher bitrates and reduced compression.

Accordingly, in some implementations of the lifting scheme, one of various adaptive prediction schemes may be applied to determine separate prediction weights for each of the even coefficients.

FIG. 10A illustrates an example of using uniform prediction weights to generate a predictor 1008, for a coefficient 1002A of a vertex v, according to some embodiments. Depending on the characteristics of the 3D mesh, always using uniform prediction weights may be inaccurate and result in a large, transformed coefficient 1010 (difference vector) in many 3D mesh frames, sub-meshes, patches, tiles, LODs, etc. During forward lifting transform, coefficients 1006A and 1004A of vertices v2 and v1, respectively, may be obtained to generate a predictor 1008 of coefficient 1002A of vertex v. For example, the vertices v1 and v2 may be from (e.g., generated at) lower LODs (k and j) than an LOD (i) of vertex v. The purpose of the prediction operation is to replace coefficient 1002A with transformed coefficient 1010 corresponding to a difference between coefficient 1002A and its predictor 1008. The size of transformed coefficient 1010 depends on an accuracy of predictor 1008. However, coefficients 1004A and 1006A may be represented by vectors that are dissimilar from coefficient 1002A. By using a uniform prediction weight (P such as 0.5), coefficient 1006A which may be more different from coefficient 1002A than coefficient 1004A from coefficient 1002A may be weighted equally in determining predictor 1008 (P_{odd,i}), which can often increase a magnitude of transformed coefficient 1010.

Further, each of coefficients 1004A and 1006A may be updated based on transformed coefficient 1010. Because the lifting operation—including prediction and update operations—are performed iteratively per each vertex per LOD, but also iterating from higher to lower LOD levels for the forward transform scheme and iterating from lower to higher LOD levels for the inverse transform scheme, any inaccurate predictions and associated updates may be propagated across vertices and LODs, which leads to lower quality of the reconstructed mesh.

FIG. 10B illustrates an example of using a similarity-based prediction scheme, e.g., an example of an adaptive prediction scheme, to determine adaptive prediction weights to generate a predictor 1012, for coefficient 1002A of a vertex v, according to some embodiments.

Depending on the 3D mesh, sub-mesh, patch, tiles, LODs, etc., the similarity-based prediction scheme may be more accurate and results in a smaller transformed coefficient 1016 (difference vector). For example, transformed coefficient 1016 resulting from using adaptive prediction weights may be smaller and more efficiently compressed in a bitstream than the larger transformed coefficient 1010.

In some examples, similar to FIG. 10A, coefficients 1006A and 1004A of vertices v2 and v1, respectively, may be obtained for predicting coefficient 1002A of vertex v. Prediction weights 1015A-B (P1′ for coefficient 1004A and P2′ for coefficient 1006A) may be determined (e.g., adjusted or scaled) by applying a similarity metric 1014 to determine a first value (e.g., α), representing a similarity between coefficient 1004A and a reference coefficient 1013, and a second value (e.g., β) representing a similarity between coefficient 1006A and reference coefficient 1013. In some examples, such as for a forwarding lifting scheme (e.g., a forward lifting wavelet transform), reference coefficient 1013 may be equal to coefficient 1002A.

In some examples, reference coefficient 1013 corresponds to transformed coefficient 1016. In a first example, reference coefficient 1013 may be determined as being transformed coefficient 1016. In a second example, reference coefficient 1013 may be determined based on a mid-point predictor (e.g., predictor 1008) that averages coefficients 1004A and 1006A. In this second example, prediction weights 1015A-B that are determined adjusts/tunes the mid-point predictor, which may balance the distribution of prediction errors across coefficients representing the displacements of the vertices of the 3D mesh.

In some examples, the values for prediction weights 1015A-B (P1′ and P2′) may be set to sum to 1. In other examples, the sums of prediction weights 1015A-B may be smaller than 1 or greater than 1.

In some embodiments, the first and second values may be compared to determine which of coefficients 1004A and 1006A is to be applied a higher prediction weight in the linear combination. For example, as shown in FIG. 10B, coefficient 1004A is more similar compared to reference coefficient 1013 and its respective prediction weight 1015A is determined to be higher than prediction weight 1015B of coefficient 1006A, which may be associated with the second value indicating lower similarity. As shown in FIG. 10B, by applying adaptive prediction weights 1015A and 1015B in a linear combination of coefficient 1004A and coefficient 1006A, a resulting predictor 1012 (P′_{odd,i}) is closer to coefficient 1002A. Increasing the accuracy of predictor 1012 results in a smaller transformed coefficient 1016, which may be determined or represented as a difference between coefficient 1002A and predictor 1012.

In some embodiments, similarity metric 1014 may be based on an angular difference between two vectors representing two coefficients, a magnitude difference between the two vectors, or a combination of the angular difference and the magnitude difference. For example, similarity metric 1014 may be a cosine similarity between two vectors representing two coefficients, respectively. For example, a value of cosine similarity (α and β) may be determined (e.g., derived) by applying a Euclidean dot product between the two vectors divided by a product of magnitudes of the two vectors. For example, for two n-dimensional vectors A and B, the value of cosine similarity (e.g., cos (θ)) may be determined as follows:

$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{1}^{2}} \cdot \sqrt{{\sum }_{i = 1}^{n} {B}_{1}^{2}}}$$

The value cosine similarity is in the interval [−1, 1] where 1 indicates that the vectors are equal, and −1 indicates that they are opposite. Therefore, a higher value of cosine similarity indicates the two vectors are more similar. In some examples, when the first and second values are the same (e.g., cos (α)=cos (β)), prediction weights 1015A-B may be set to the same value, e.g., 0.5.

In some examples, similarity metric 1014 may be scaled by a value, e.g., a magnitude (vector norm) of the updated coefficient corresponding to the similarity. For example, the first value may be based on the first cosine similarity (between coefficient 1004A and reference coefficient 1013) multiplied by the magnitude of coefficient 1004A (i.e., vector norm of coefficient 1004A). For example, the second value may be based on the second cosine similarity (between coefficient 1006A and reference coefficient 1013) multiplied by the magnitude of coefficient 1006A (i.e., vector norm of coefficient 1006A).

In some embodiments, similarity metric 1014 may be an angular difference between two vectors. For example, the value α may be determined as the angle between the vector representing reference coefficient 1013 and the second vector representing coefficient 1004A. Similarly, the value β may be determined as the angle between the vector representing reference coefficient 1013 and the first vector representing coefficient 1006A. The value may be in an interval from 0 to 360 degrees (°). In some examples, the value may be quantified in radians.

In some embodiments, similarity metric 1014 may be a centered cosine similarity (e.g., Pearson correlation coefficient) between two vectors representing two coefficients. For example, each of the two vectors may be normalized by subtracting the mean vector (e.g., average vector) of the two vectors before a cosine similarity is computed.

In some embodiments, similarity metrics 1014 may also be based on magnitudes of the two vectors (e.g., a dot product) and/or a distance between the vectors. Examples of the distance may be a Euclidean distance or a Manhattan distance, a Minkowski distance, etc.

For example, similarity metric 1014 may be a dot product (i.e., a scalar product) between two vectors. For example, a first value representing a similarity between coefficient 1004A and reference coefficient 1013 may be determined based on a first dot product between coefficient 1004A and reference coefficient 1013. For example, a second value representing a similarity between coefficient 1006A and reference coefficient 1013 may be determined based on a second dot product between coefficient 1006A and reference coefficient 1013.

In some examples, each of the two similarities (e.g., represented by dot products) may be scaled by a value, e.g., divided by a magnitude (vector norm) of reference coefficient 1013. In these examples, each of the first and second values may be equal to a first and second similarity, respectively, scaled by the same value.

In some embodiments, FIG. 10B may also represent an example of determining prediction weights 1015A-B that are adaptive according to similarities determined for coefficients 1004A and 1006A when performing inverse lifting transform. For example, as in forward lifting transform scheme, the first and second vertices (v1 and v2) may be obtained for vertex v. However, instead of coefficients 1002A, 1004A, and 1006A being obtained, transformed coefficients (e.g., a coefficient t_{odd} corresponding to transformed coefficient 1016, a first coefficient t_{E1} corresponding to coefficient 1004A, and a second coefficient t_{E2} corresponding to coefficient 1006A) may be obtained as shown in FIG. 9B. For example, a first transformed coefficient (t_{E1}) and a second transformed coefficient (t_{E2}) of the first and second vertices (v1 and v2), respectively, may be obtained for transformed coefficient 1016 (t_{Odd,i}) of vertex (v) based on the first and second vertices being used to generate the vertex. For example, edge information may be obtained based on the vertex and the edge information may include indices indicating the first and second vertices.

After performing the update operation as shown in FIG. 9B, coefficient 1004A may correspond to an updated first coefficient and coefficient 1006A may correspond to an updated second coefficient. For example, coefficient 1004A and coefficient 1006A may be determined for the first and second vertices, respectively, based on updating the first and second transformed coefficients, respectively, using the transformed coefficient 1016 (t_{Odd,i}). In the inverse lifting transform scheme, coefficient 1002A corresponds to inverse transforming transformed coefficient 1016 according to predictor 1012. Accordingly, applying similarity metric 1014 to determine a first similarity between reference coefficient 1013 and coefficient 1004A may be determined between reference coefficient 1013 and the updated first coefficient. Also, applying similarity metric 1014 to determine a second similarity between reference coefficient 1013 and coefficient 1006A may be determined between reference coefficient 1013 and the updated second coefficient.

In some embodiments where FIG. 10B refers to an iteration of inverse lifting transform, reference coefficient 1013 may be obtained based on transformed coefficient 1016. In some examples, reference coefficient 1013 may be determined as transformed coefficient 1016. In some examples, reference coefficient 1013 may be determined as a mid-point predictor averaging (e.g., predictor 1008) coefficient 1004A and 1006A. In some examples, reference coefficient 1013 may be determined as an approximation of coefficient 1002A. For example, reference coefficient 1013 may be determined as a sum of transformed coefficient 1016 and the average of coefficient 1004A and 1006A (e.g., mid-point predictor 1008). Note that the averaging of coefficient 1004A and 1006A may correspond to averaging the updated first coefficient and the updated second coefficient.

FIG. 10C illustrates an example of using a normal-based prediction scheme, e.g., an example of an adaptive prediction scheme, to determine adaptive prediction weights to generate a predictor 1021, for coefficient 1002A of a vertex v, according to some embodiments. Specifically, the vertex normals 1024 and 1026 of vertices v1 and v2 are compared to the vertex normal of v to determine prediction weights associated with coefficients 1004A and 1006A, respectively (or updated coefficients 1004A and 1006A in the case of inverse lifting transform). Depending on the 3D mesh, sub-mesh, patch, tiles, LODs, etc., the normal-based prediction scheme may be more accurate and results in a smaller transformed coefficient 1028 (difference vector). For example, transformed coefficient 1028 resulting from using adaptive prediction weights may be smaller and more efficiently compressed in a bitstream than the larger transformed coefficient 1010.

In general, the direction of displacement vector of each vertex trends to be aligned with its normal vector direction due to the subdivision scheme used to generate the reconstructed mesh. Accordingly, the accuracy of prediction may be enhanced using normal vector similarity. For example, vertex v1 may have a vertex normal 1024 more similar to vertex normal 1022 of vertex v than vertex normal 1026 of vertex v2 is to vertex normal 1022. In this case, if the direction of displacement vector (e.g., corresponding to coefficient 1002A) trends to be aligned with normal vector 1022 at vertex v, the displacement vector of vertex v2 (e.g., corresponding to coefficient 1004A) may be a better predictor and is associated with a higher prediction weight when combining the even coefficients to generate a predictor for coefficient 1002A.

In some embodiments, the similarities between vertex normals 1024-1026 (at vertices v1 and v2) and vertex normal 1022 may be determined as follows:

$$cos\_v \_v 1 = max ( 0 , normal ( v ) \cdot normal ( v 1 ) ) \\ cos\_v \_v 2 = max ( 0 , normal ( v ) \cdot normal ( v 2 ) ) \\ sum\_cos = cos\_v \_v 1 + cos\_v \_v 2 \\ if ( sum\_cos > 0 ) \\ predicted disp ( v ) = ( cos\_v \_v 1 / sum\_cos ) * disp ( v 1 ) + ( cos\_v \_v 2 / sum\_cos ) * disp ( v 2 )$$

In the examples above, normal (x) represents a normal vector of vertex x, disp(x) represents displacement vector (e.g., coefficient) of vertex x, and cos_v_v1 and cos_v_v2 represent cosine similarities of each normal vector. The cosine similarity may be an inner product of each normal vectors. In the example similarity metric above, cos_v_v1 and cos_v_v2 are set to the larger of the cosine similarity or 0 to avoid using displacement vectors having a large angular difference from that at vertex v. The predicted value of displacement vector is calculated by using a weighted average with this cosine similarity. By introducing this metric, the displacement vector of vertex v1 or v2 which has a large cosine similarity of normal vector is used with higher weight (or priority) in calculating predicted displacement vector of the target vertex v.

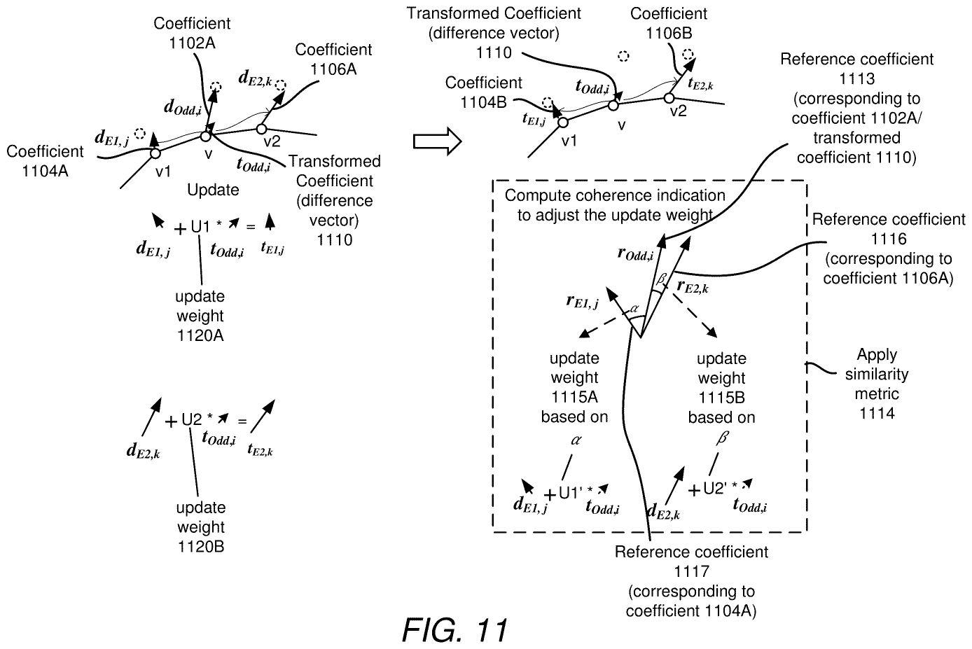

FIG. 11 illustrates an example of the benefits of using adaptive update weights instead of to generate updated coefficients 1104B and 1106B, for respective coefficients 1104A and 1106A of respective vertices v1 and v2, respectively, according to some embodiments.

For example, during forward lifting transform, coefficients 1104A and 1106A of vertices v1 and v2, respectively, may be obtained to generate a predictor of coefficient 1102A of vertex v. For example, the vertices v1 and v2 may be from (e.g., generated at) lower LODs (k and j) than an LOD (i) of vertex v. The purpose of the prediction operation is to replace coefficient 1102A with transformed coefficient 1110 corresponding to a difference between coefficient 1102A and its predictor 1108. The size of transformed coefficient 1110 depends on an accuracy of predictor 1108.

Further, each of coefficients 1104A and 1106A may be updated based on transformed coefficient 1110 using update weights 1120A and 1120B, respectively. However, the predictor used to update coefficients 1104A and 1106A may be represented by a vector that is dissimilar from one or both of coefficients 1104A and 1106A. In some embodiments, by using update weights 1120A-B (U1 and U2) that are independent of similarity between coefficients, coefficient 1104A which may be very different from the predictor may be weighted according to update weight 1120A to be updated to be significantly different from coefficient 1106A, which may lead to less accurate prediction of coefficients in subsequent iterations of the lifting transform scheme.

Because the lifting operation—including prediction and update operations—are performed iteratively per each vertex per LOD, but also iterating from higher to lower LOD levels for the forward transform scheme and iterating from lower to higher LOD levels for the inverse transform scheme, inaccurate predictions and associated updates may be propagated from across vertices and LODs, which leads to lower quality of the reconstructed mesh.

In contrast, updated coefficients 1104B and 1106B corresponding to coefficients 1104A and 1106A, respectively, resulting from adaptive update weights 1115A-B, respectively, are closer to coefficients 1104A and 1106B, respectively, before the update operation.

In some examples, coefficients 1104A and 1106A of vertices v1 and v2, respectively, may be obtained for predicting coefficient 1102A of vertex v. As explained above, transformed coefficient 1110 may be determined as a difference between coefficient 1102A and a predictor determined from the first and second coefficients. In some examples, the predictor may be determined as a linear combination of the first and second coefficients. For example, the predictor may be determined as an average of the first and second coefficients.

Update weights 1115A-B (U2′ for coefficient 1106A and U1′ for coefficient 1104A) may be determined (e.g., adjusted or scaled) by applying a similarity metric 1114 to determine a first value (e.g., α), representing a similarity between reference coefficient 1117 (corresponding to coefficient 1104A) and a reference coefficient 1113, and a second value (e.g., β) representing a similarity between a reference coefficient 1116 (corresponding to coefficient 1104A) and reference coefficient 1113. For example, reference coefficient 1113 may correspond to coefficient 1102A or transformed coefficient 1116 depending on whether forward lifting transform or inverse lifting transform is performed, respectively.

In some examples, for forward lifting transform, reference coefficient 1113 corresponds to coefficient 1102A. In a first example, reference coefficient 1113 may be determined as coefficient 1102A. In a second example, reference coefficient 1113 may be determined as transformed coefficient 1110. In a third example, reference coefficient 1113 may be determined as a mid-point predictor that averages coefficients 1104A and 1106A.

In some examples, for forward lifting transform, reference coefficients 1117 and 1116 may be obtained (e.g., determined) as coefficient 1104A and 1106A, respectively.

In some examples, for inverse lifting transform, reference coefficients 1117 and 1116 may be obtained (e.g., determined) by updating coefficients 1104A and 1106A, respectively, according to a first and second reference update weights, respectively, to generate a first and a second reference updated coefficients, respectively.

In some examples, for inverse lifting transform, reference coefficient 1113 corresponds to transformed coefficient 1116. In a first example, reference coefficient 1113 may be determined as being transformed coefficient 1116. In a second example, reference coefficient 1113 may be determined as a mid-point predictor that averages coefficients 1104A and 1106A. In a third example, reference coefficient 1113 may be determined as a mid-point predictor that averages the first and second reference update coefficients. In a fourth example, reference coefficient 1113 may be determined as a sum of transformed coefficient 1116 and a linear combination of coefficients 1104A and 1106A. In a fifth example, reference coefficient 1113 may be determined as a sum of transformed coefficient 1116 and a linear combination of the first and second reference updated coefficients. In the fourth and fifth examples, the linear combination may be an average in which each weight in the linear combination is the same (e.g., equal to 0.5).

In some examples, the values for update weights 1115A-B (U1′ and U2′) may be set to sum to 1. In other examples, the sums of update weights 1115A-B may be smaller than 1 or greater than 1.

In some embodiments, the first and second values may be compared to determine which of coefficients 1104A and 1106A is to be applied a higher update weight. For example, as shown in FIG. 11, reference coefficient 1116 corresponding to coefficient 1106A is more similar directionally compared to reference coefficient 1113 and its respective update weight 1115B is determined to be higher than prediction weight 1115A of coefficient 1104A corresponding to reference coefficient 1117, which may be associated with the second value indicating lower similarity. As shown in FIG. 11, by applying adaptive update weights 1115A and 1115B, coefficient 1104B, resulting from the update, is closer to coefficient 1104A before the update. Increasing the accuracy of updating coefficients results in more accurate predictions in the next iterations of the lifting transform, which leads to a smaller transformed coefficients.

In some examples, similarity metric 1114 may be based on an angular difference between two vectors representing two coefficients, a dot product between the two vectors, a magnitude difference between the two vectors, or a combination of the angular difference and the magnitude difference. For example, similarity metric 1114 may be a cosine similarity between two vectors representing two coefficients, respectively. For example, a value of cosine similarity (α and β) may be determined (e.g., derived) by applying a Euclidean dot product between the two vectors divided by a product of magnitudes of the two vectors. For example, for two n-dimensional vectors A and B, the value of cosine similarity (e.g., cos (θ)) may be determined as follows:

$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{1}^{2}} \cdot \sqrt{{\sum }_{i = 1}^{n} {B}_{1}^{2}}}$$

The value cosine similarity is in the interval [−1, 1] where 1 indicates that the vectors are equal, and −1 indicates that they are opposite. Therefore, a higher value of cosine similarity indicates the two vectors are more similar. In some examples, when the first and second values are the same (e.g., cos (α)=cos (β)), prediction weights 1115A-B may be set to the same value, e.g., 0.5.

In some examples, similarity metric 1114 may be an angular difference between two vectors. For example, the value α may be determined as the angle between the vector representing reference coefficient 1113 and the second vector representing coefficient 1104A. Similarly, the value β may be determined as the angle between the vector representing reference coefficient 1113 and the first vector representing coefficient 1106A. The value may be in an interval from 0 to 360 degrees (°). In some examples, the value may be quantified in radians.

In some examples, a threshold value may be used to limit the adjustment of update weights so that the coherence information before and after the update operation for the coefficients 1104A and 1106B will not be modified, which may otherwise result in a mismatch of encoded and decoded mesh (misalignment of the encoding and decoding process). For example, for α>β, if the update weight is modified to be double that of its original value, the updated displacement may be used, and the coherence indication associated with that may be different. In this case, the coherence information that is computed from the encoder side and decoder side may be different and causes a misalignment of the encoding and decoding process. Misalignment will redcue the compression performance and reconstruction quality for the mesh.

Accordingly, in some examples, the update weight may be adjusted based on the angle. For example,

$${U}^{′} = U * \frac{180 - ( α - β )}{180} , {U}^{′} = U * \frac{cos α}{cos β} , {U}^{′} = 0 ( if α > β ) .$$

In some examples, similarity metric 1114 may be a centered cosine similarity (e.g., Pearson correlation coefficient) between two vectors representing two coefficients. For example, each of the two vectors may be normalized by subtracting the mean vector (e.g., average vector) of the two vectors before a cosine similarity is computed.

In some examples, similarity metrics 1114 may also be based on magnitudes of the two vectors (e.g., a dot product) and/or a distance between the vectors. Examples of the distance may be a Euclidean distance or a Manhattan distance, etc.

In some embodiments, FIG. 11 may also represent an example of determining update weights 1115A-B that are adaptive according to similarities determined for coefficients 1104A and 1106A when performing inverse lifting transform. For example, as in forward lifting transform scheme, the first and second vertices (v2 and v1) may be obtained for vertex v. However, instead of coefficients 1104A, 1102A, and 1106A being obtained, transformed coefficients (e.g., a coefficient t_{odd} corresponding to transformed coefficient 1116, a first coefficient t_{E1}, and a second coefficient t_{E2}) may be obtained as shown in FIG. 9B. After performing the update operation as shown in FIG. 9B, coefficient 1104A may correspond to an updated second coefficient and coefficient 1106A may correspond to an updated first coefficient. In the inverse lifting transforms scheme, coefficient 1102A corresponds to inverse transforming transformed coefficient 1116 according to predictor 1112.

In some examples, further to the non-adaptive (e.g., uniform) update scheme, the adaptive per-LOD update scheme, and the similarity-based update scheme of FIG. 11, another adaptive update scheme may include a valence-based update scheme. In the valence-based update scheme, a valence at a vertex to be updated is considered to determine an update weight used to update a displacement signal or coefficient at that vertex. For example, a contribution m67453 titled “[V-DMC] [EE4.7-Test 7.1 report] Valence-based adaptive lifting update” describes examples of generating the update weight based on valence information.

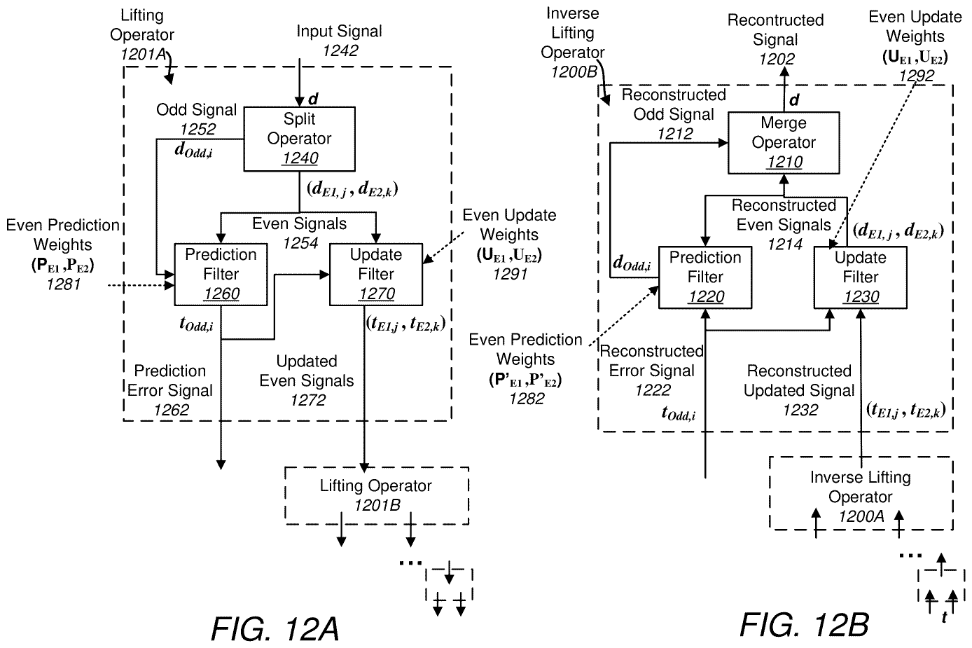

FIG. 12A and FIG. 12B illustrate each iteration of the lifting scheme, described above in FIG. 8B and FIG. 8C, in greater detail.

FIG. 12A illustrates an example forward lifting scheme to transform displacements of a 3D mesh (e.g., a mesh frame of the 3D mesh) to wavelet coefficients, according to some embodiments. As explained above, the forward lifting scheme may include a plurality of lifting operations that are iteratively performed a number of instances corresponding to a number of LODs of the 3D mesh frame. Each lifting operation may correspond to operations performed in a lifting operator 1201. For example, a lifting operator 901A may be applied to input signal 1242 corresponding to the displacements (e.g., displacement values determined by the encoder). Split operator 1240 may determine odd signal 1252 and corresponding even signal(s) 1254 for predicting the odd signal 1252. For example, odd signal 1252 may correspond to a displacement value (e.g., a coefficient) associated with a vertex, of vertices of the 3D mesh, at a first LOD (e.g., LOD_{N}) of LODs associated with the displacements. Split operator 1240 may determine even signals 1254 comprising two displacement values (e.g., coefficients) corresponding to two respective vertices, from one or more lower LODs (e.g., LOD₀-LOD_{N-1}) than the LOD, forming an edge associated with the vertex. For example, these two vertices may be the closest vertices that sandwich the vertex on the edge and that are from the one or more lower LODs. In some examples, split operator 1240 may determine the edge of the first vertex based on the subdivided mesh and then determine the two vertices on the same edge.

Prediction filter 1260 (e.g., also referred to as prediction step or prediction operation) may generate a predictor for odd signal 1252 based on a linear combination of even signals 1254 weighted based on prediction weights 1281 (P_{E1}, P_{E2}).

In some embodiments, an adaptive prediction such as a similarity-based prediction scheme may be applied. For example, in the similarity-based prediction scheme, prediction weights 1281 may be adaptively determined based on applying a similarity metric between each of even signals 1254 and a reference signal (e.g., coefficient) corresponding to odd signal 1252, as explained above with respect to FIG. 10B.

For example, prediction filter 1260 may determine the displacement predictor as a linear combination of the two even signals 1254 having respective prediction weights 1281. Prediction filter 1260 may transform odd signal 1252 (e.g., the displacement at the vertex) into a wavelet coefficient corresponding to prediction error signal 1262. For example, prediction error signal 1262 may be determined as a difference between the odd signal 1252 and the displacement predictor. Accordingly, prediction filter 1260 may replace odd signal 1252 with a difference between odd signal 1252 (e.g., original value) and its prediction. Thus, lifting operator 1101A may update (e.g., replace) displacement signals in place without requiring separately storing updated signals.

Update filter 1270 may update even signals 1254 using prediction error signal 1262 according to update weights corresponding to the even signals 1254. Even signals 1254 may be converted (e.g., replaced) with updated even signals 1272. In some examples, when uniform update weights are applied (e.g., enabled or selected), the update weight may be a predetermined value, e.g., ½, ¼, ⅛, or 1/16. In some examples, when the uniform update weight is applied, a value of the update weight may be signaled by the encoder in the bitstream to the decoder.

In some embodiments, in an LOD-based update scheme, update weights may be adjusted (e.g., adaptive to) based on the LODs corresponding to the lifting operations in which the update weights are used. For example, the update weight may be determined according to the LOD associated with the vertex corresponding to odd signal 1252. For example, a first update weight (e.g., “update Weight” parameter, which may be a default or fixed value) may be scaled by a scaling value (e.g., “adaptive_ratio” value). For example, the scaling value (e.g., “adaptive_ratio” value) may be a power of a scaling factor (e.g., “UpdateWeightScale” parameter) having an exponent associated with a total number of LODs (e.g., a count/quantity of LODs associated with the 3D mesh, “lod_count” parameter) and an index of the LOD (e.g., a current LOD level, “lod_current” parameter) corresponding to the lifting operation. For example, if the first update weight (e.g., “updateWeight” parameter) equals ⅛, the first update weight (e.g., “updateWeight”) of an update operation for an LOD (e.g., index of 2 indicating LOD₂) level can be adjusted (e.g., updated or adapted) to 1/16 if the scaling factor (e.g., “UpdateWeightScale” parameter) is equal to ½ and the LOD difference between the total number of LODs (e.g., “lod_count” parameter being 4) and the current LOD (e.g., “lod_current” parameter being 3) equals to 1. Thus, the greater the difference between the total number of LODs and the current LOD, the greater the impact the scaling factor (e.g., “UpdateWeightScale” parameter) will have for the update weight in the update filtering (e.g., update step or update operation). Since the scaling factor may be less than 1, this means the greater the difference, the smaller the adjusted update weight will become.

In some examples, the update weight may be further adjusted (e.g., increased or decreased) based on a geometrical distance between the two vertices. For example, assuming an update weight in LOD 3 is used with a value of ¼ to update the displacement value with the error signal to prepare it for the next prediction step. The update value may be decreased to ½ of its value to ⅛, reducing the impact of coming error signal computed in LOD 2 level.

Accordingly, update filter 1270 may replace even signals 1252 with updated even signals 10701172. Updated even signals 1272 may include a sum of prediction error signal 1262 scaled by an update weight and corresponding even signals 1254. Thus, lifting operator 1101A may update (e.g., replace) displacement signals in place without requiring separately storing updated signals.

In some embodiments, when an adaptive update scheme is applied, separate even update weights (U_{E1}, U_{E2}) (e.g., even update weights 1291 in lifting operator 1201A, even update weights 1292 in inverse lifting operator 1200B) may be determined for each signal of the pair of even signals. For example, the adaptive update scheme may be an LOD-based update scheme that is adaptive of LODs of the even signals so that each of the update weights for an even signal may be further adjusted based on an LOD of a vertex corresponding to that even signal.

As shown in FIGS. 12A-B, lifting operations 1001A-B are iterated from signal samples (e.g., displacement signals and corresponding wavelet coefficient representations) in higher LODs to lower LODs. In each iteration, lifting operator 1201 takes a signal, processed in a previous lifting operation at a higher LOD, and splits (e.g., separates) it into signals corresponding to a lower LOD to generate a predicted and updated signal. Lifting operator 1201 are iteratively performed for each lower LOD until the lowest LOD level is processed at which point all displacement signals (e.g., input signal 1242) will have been transformed into wavelet coefficients. For example, a base mesh of 1200 vertices may be subdivided into an up-sampled mesh with, e.g., 57,600 vertices across 4 LOD levels (e.g., LOD₀ comprising vertices with indexes 1-1100, LOD₁ comprising vertices with indexes 1101-3600, LOD2 comprising vertices with indexes 3601-14400, and LOD₃ comprising vertices with indexes 14401-57600. The associated displacements (e.g., displacement values) have the same order as these vertices. Lifting operators 1201A-B may iterate from the higher LOD, which is LOD 3 in this example, in lifting operator 1201A. Then the lifting operations are executed iteratively, e.g., to lifting operator 1201B, etc., until all the signals are processed across all LODs.

As shown in the forward lifting scheme, even signals 1254 (d_{E1,j}, d_{E2,k}) may be determined for an odd signal 1252 (d_{Odd,i}). The i, j, and k variables indicate the i-th, j-th, and k-th LOD (e.g., index of LOD or level of LOD).

In some examples, prediction error signal 1262 may be determine based on a predictor p_{Odd}=P2′ *(d_{E1,j})+P1′*(d_{E2,k}), where t_{Odd,i}=d_{Odd,i}−p_{Odd}, as explained above with respect to FIGS. 9A, 10B, 10C, etc.

In some embodiments, the updated prediction signals are dependent on an update weight that is the same when the update scheme is a default/uniform update scheme:

$${t}_{E 1 , j} = {d}_{E 1 , j} + U * {t}_{Odd , 1} \\ {t}_{E 2 , k} = {d}_{E 2 , k} + U * {t}_{Odd , 1}$$

For example, U=U₀*U_{Odd} (e.g., U_{Odd} may be based on LOD i of d_{Odd}, U_{Odd}=pow(S_{odd}, N−i)). For example, U=U₀+offsetᵢ.

In some embodiments, updates weights are determined separately when the update scheme is an adaptive update scheme:

$${t}_{E 1 , j} = {d}_{E 1 , j} + {U}_{E 1} * {t}_{Odd , 1} \\ {t}_{E 2 , k} = {d}_{E 2 , k} + {U}_{E 2} * {t}_{Odd , 1}$$

As explained above, the adaptive update scheme may be any one of a plurality of update schemes such as valence-based update scheme, LOD-based update scheme adaptive to LOD of the even coefficients/signals, or a similarity-based update scheme, etc.

FIG. 12B illustrates an example of inverse lifting scheme to transform wavelet coefficients to displacements of a 3D mesh, according to some embodiments. For example, inverse lifting operators 1200A-B of the inverse lifting scheme may inverse operation of the lifting scheme described in FIGS. 12A-B. For example, instead of iterating from higher LODs to lower LODs in the forward lifting scheme, lower LODs in the inverse lifting scheme are processed before higher LODs. Previously processed wavelet coefficients may be input as reconstructed updated signal 1232 and reconstructed error signal 1222 to inverse lifting operator 1200B from a previous iteration of the inverse lifting scheme, e.g., from inverse lifting operator 1200A.

For example, for a wavelet coefficient of a vertex at an LOD, reconstructed updated signal(s) 1232 may be determined corresponding to the two vertices as determined by the forward lifting scheme). Update filter 1230 may determine a reconstructed even signal(s) 1214 based on reconstructed error signal 1222 and the update weight (e.g., the same update weight(s) applied by update filter 1270 in lifting operator 1101A in the forward lifting scheme). In some embodiments, the decoder may obtain (e.g., decode) an indication of whether adaptive update weights are enabled (or disabled). Based on the indication of adaptive update weights being not enabled (or disabled), the update weight may be a uniform value that is used for lifting operations across all LODs associated with vertices of the 3D mesh.

In some embodiments, when adaptive update weights are used (e.g., based on the indication of adaptive update weights being enabled or as a default mode), update filter 1230 may determine the update weight (e.g., an adjusted update weight) specific to a vertex. For example, in the adaptive LOD-based update scheme, the update weight may be determined according to an LOD associated with a vertex corresponding to reconstructed error signal 1222.

Further, prediction filter 1220 may determine a displacement predictor based on prediction weights 1282 and updated signals (reconstructed even signals 1214) from update filter 1230. In some examples, prediction weights 1282 may be similarly computed as prediction weights 1281. In some embodiments, the decoder may obtain (e.g., decode) an indication of whether adaptive prediction weights are enabled (or disabled). Based on the indication of adaptive prediction weights being not enabled (or disabled), the prediction weight may be a uniform value that is used for lifting operations.

In some embodiments, when adaptive prediction weights are used (e.g., based on the indication of adaptive prediction weights being enabled or as a default mode), update filter 1230 may determine the prediction weights adaptively, such as, according to a similarity-based prediction scheme in of computing similarities for reconstructed even signals 1214, as described in FIG. 10B, or a normal-based prediction scheme described in FIG. 10C, or another adaptive prediction scheme.

Merge operator 1210 may combine the displacement predictor and the reconstructed error signal 1222.

For example, for reconstructed error signal D₁ corresponding to a first vertex, two reconstructed signal(s) 1232 Eᵤ₁ and Eᵤ₂ corresponding to a second vertex and a third vertex, respectively, may be determined. As explained above, as similarly performed by the encoder, the decoder may also apply a plurality of iterations of a subdivision scheme to a decoded base mesh (e.g., reconstructed base mesh) to determine a subdivided mesh comprising vertices at a plurality of LODs corresponding to the plurality of iterations. For example, each successive iteration of the subdivision scheme may generate vertices at a next lower LOD. Therefore, for the first vertex from a first LOD, the decoder may determine the second and third vertices, from lower LODs, on the same edge as the first vertex. For example, the second and third vertices may be vertices, from LODs lower than the first LOD, that are closest to the first vertex on the same edge as the first vertex. Then, update filter 1230 may generate reconstructed even signals 1214 E₁ and E₂ based on reconstructed signal(s) 1232 Eᵤ₁ and Eᵤ₂ as follows: E₁=Eᵤ₁−wᵤ*D₁ and E₂=Eᵤ₂−wᵤ*D₁, where wᵤ is the update weight. Accordingly, update filter 1230 may replace reconstructed updated signal 1232 (e.g., updated from a previous iteration such as inverse liftin operator 1100A) with reconstructed even signal 1214. Thus, inverse lifting operator 1100B may update (e.g., replace) displacement signals in place without requiring separately storing updated signals.

Prediction filter 1220 may determine a prediction P₁ for a displacement signal corresponding to the vertex as follows: P′_{odd}=P1′ *E₁+P2′*E₂ where P1 and P2 are the prediction weights. Finally, reconstructed odd signal 1212, O₁ may be determined based on the prediction P′_{odd} and the reconstructed error signal 1222 (t_{odd}) as follows: O₁=t_{odd}+P′_{odd}. Accordingly, prediction filter 1220 may replace reconstructed error signal 1222 (e.g., corresponding or representing a displacement signal of an odd signal) with reconstructed odd signal 1212.

Merge operator 1210 may order reconstructed odd signal 1212 and reconstructed even signal 1214 to be further processed at a next higher LOD corresponding to a next inverse lifting operator 1200.

As shown in the inverse lifting scheme, reconstructed updated signal 1232 (t_{E1,j},t_{E2,k}) may be determined for a reconstructed error signal 1222 (t_{Odd,i}). The i, j, and k variables indicate the i-th, j-th, and k-th LOD (e.g., index of LOD or level of LOD).

In some examples, the update weight is the same: d_{E1,j}=t_{E1,j}−U*t_{Odd,i} and d_{E2,k}=t_{E2,k}−U*t_{Odd,i}

In some embodiments, different update weights are determined, as explained above:

$${d}_{E 1 , j} = {t}_{E 1 , j} - {U}_{E 1} * {t}_{Odd , 1} \\ {d}_{E 2 , k} = {t}_{E 2 , k} - {U}_{E 2} * {t}_{Odd , 1}$$

In some embodiments, the update weights for reconstructed updated signals 1232 may be determined as follows:

$${U}_{E 1} = U * {U}_{1} \\ {U}_{E 2} = U * {U}_{2}$$

For example, U=U₀ or (U₀*U_{Odd}).

In some examples, the update weights may be determined as follows (where N may be a total number of LODs minus 1):

$${U}_{1} or {U}_{E 1} = pow ( {S}_{even} , N - j ) \\ {U}_{2} or {U}_{E 2} = pow ( {S}_{even} , N - k )$$

In some embodiments, Sₑᵥₑₙ may be a scaling factor signaled by the encoder to the decoder. In some examples, the first update weight (e.g., U₁ or U_{E1}) and/or the second update weight (e.g., U₂ or U_{E2}) may be determined based on a scaling factor (Sₑᵥₑₙ). For example, the scaling factor may be associated with updating even samples according to LODs corresponding those even samples. In some examples, the scaling factor may be signaled by an indication in a bitstream (e.g., by the encoder to the decoder). For example, the indication of the scaling factor may comprise a value of the scaling factor, a first and a second indication for a numerator and a denominator of a fraction representing the scaling factor, or an index to the scaling factor from a plurality of scaling factors (e.g., a list, array, or table of scaling factors).

In some examples, the update weight for each even sample may be determined (e.g., computed) as a power of the scaling factor dependent on an LOD of each even sample.

In some examples, even weights 1280 may be determined as follows:

$${U}_{E 1} = U + {offset}_{j} \\ {U}_{E 2} = U + {offset}_{k}$$

where the offset may be signaled for each LOD.

As explained above, as part of encoding and decoding a 3D mesh, a subdivided mesh is generated from a base mesh. Then, displacements of vertices of the subdivided mesh are generated and encoded by the encoder in a bitstream, from which a decoder obtains and decodes the displacements to reconstruct the 3D mesh. Each iteration of subdivision corresponds to another LOD. In some embodiments, the subdivision scheme may be one of a plurality of subdivision schemes. For example, the plurality of subdivision schemes may include one or more of the following example schemes: a midpoint subdivision using an arithmetic mean (referred to as “mid” subdivision), a midpoint subdivision using a harmonic mean, a loop subdivision, an LS3 subdivision, a Butterfly subdivision, a normal-based subdivision, etc.

In some embodiments, each iteration of iterations of subdivision to obtain the subdivided mesh from the base mesh may select one of the plurality of subdivision schemes. For example, two iterations of the iterations may apply different subdivision schemes to generate the final subdivided mesh.

In some examples, the selection of subdivision scheme for each iteration of subdivision may be predetermined (e.g., using mid-mid-loop or normal-normal-loop for 3 iterations corresponding to 3 LODs).

In some examples, the encoder may select a subdivision scheme for each iteration/LOD and signal the selected subdivision scheme per LOD in the bitstream to the decoder.

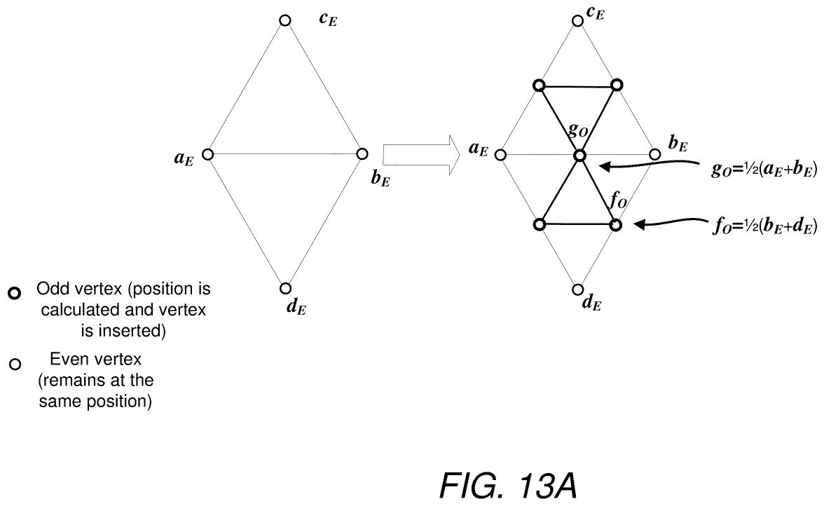

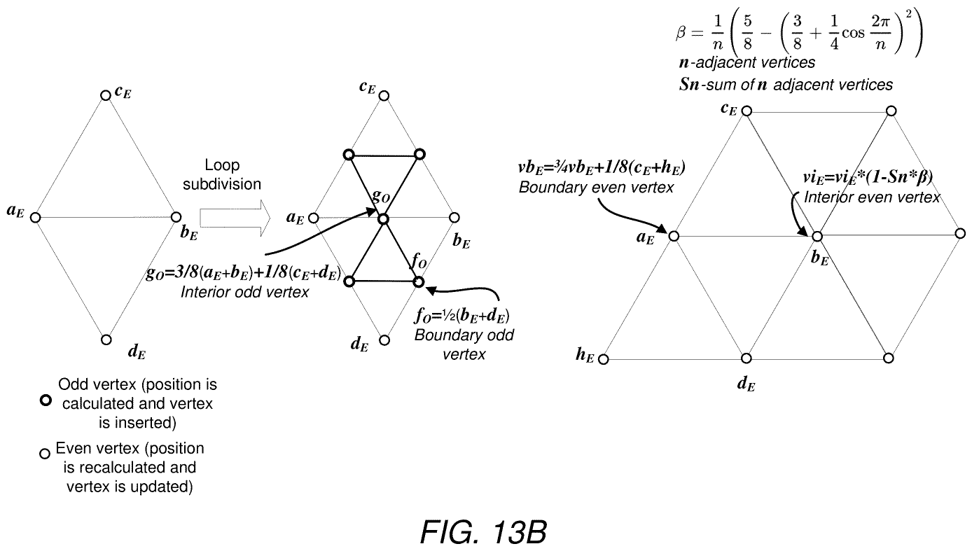

FIG. 13A illustrates an example of midpoint subdivision, according to some embodiments. In midpoint subdivision, odd vertices are generated from pairs of the even vertices based on the midpoint of an edge formed by a pair of even vertices. For example, an odd vertex g0 is determined as a midpoint or average of the edge formed by vertex a_{E} and a_{B}.

FIG. 13B illustrates an example of loop subdivision, according to some embodiments. In contrast to midpoint subdivision, new positions are calculated for both odd and even vertices. As shown in FIG. 13B, interior and boundary odd vertices are generated according to different weights of edges. And, interior and boundary even vertices are also adjusted according to different weights. Accordingly, positions of both existing and new vertices are adjusted by performing weighted sum operations on adjacent vertices and the current vertex. The loop subdivision scheme generally results in smoother surfaces.

In some embodiments, a Least Squares Subdivision Surfaces (LS3) subdivision scheme involves three steps: splitting to add new vertices, relaxation to smooth them, and projection onto an algebraic surface for refinement. This scheme improves the smoothness and visual quality of 3D polygonal meshes, especially around complex areas.

In some embodiments, a normal-based subdivision scheme enhances the subdivision process by incorporating normal vectors. This scheme generates the new subdivision point by introducing an additional term, known as the refinement vector, which is derived from the normal vectors of the vertices used in the subdivision. Other subdivision schemes further enhance the normal-based subdivision scheme.

In some embodiments, an adaptive-mean subdivision scheme uses a normal-based condition to adaptively decide between the harmonic mean and arithmetic mean when subdividing edges in an iteration of subdivision. The dot product of normal vectors from adjacent triangles (to the mesh edge) determines whether to apply the harmonic or arithmetic mean for each edge during subdivision.

While various types of prediction and update schemes for lifting wavelet transform have been proposed, no single scheme can almost derive the most optimal prediction and update weights, respectively. One possible reason is due to the varying displacement residual statistics, such as standard deviation, across different LODs of vertices of the 3D mesh. Moreover, using different subdivision schemes across iterations (e.g., per LOD) of subdivision may also result in varying displacement residual characteristics. This inconsistency results in suboptimal performance of any one prediction and/or update scheme.

Embodiments of the present disclosure are related to adaptively selecting a prediction and/or update scheme in lifting wavelet transform (e.g., including forward and inverse lifting wavelet transform operations) of displacements for 3D mesh. By adaptively selecting between prediction and/or update scheme per LOD, displacements may be more accurate predicted for coefficients at each LOD, which leads to reduced bitrate and improved compression. In some embodiments, the encoder may select a prediction and/or update scheme per LOD and signal one or more indications of selected prediction and/or update schemes per LOD in the bitstream to a decoder. Then, the decoder may decode and obtain, per LOD, an indication of a prediction scheme (from a set/plurality of prediction schemes) and/or an indication of an update scheme (from a set/plurality of update schemes).

In some embodiments, while selecting and signaling a prediction and/or update scheme per LOD may lead to higher compression of displacement signals, additional complexity is needed at the encoder. Additionally, additional bitrate is added to signal these schemes per LOD. In some embodiments, to reduce excess signaling per LOD, a prediction scheme and/or an update scheme in the lifting wavelet transform may be determined (e.g., selected or derived) according to a subdivision scheme selected for or associated with a given LOD. In some examples, this derivation approach pairs a prediction and/or an update scheme with each subdivision scheme to achieve a balance of improved/reduced displacements without requiring additional signaling of specific schemes per LOD.

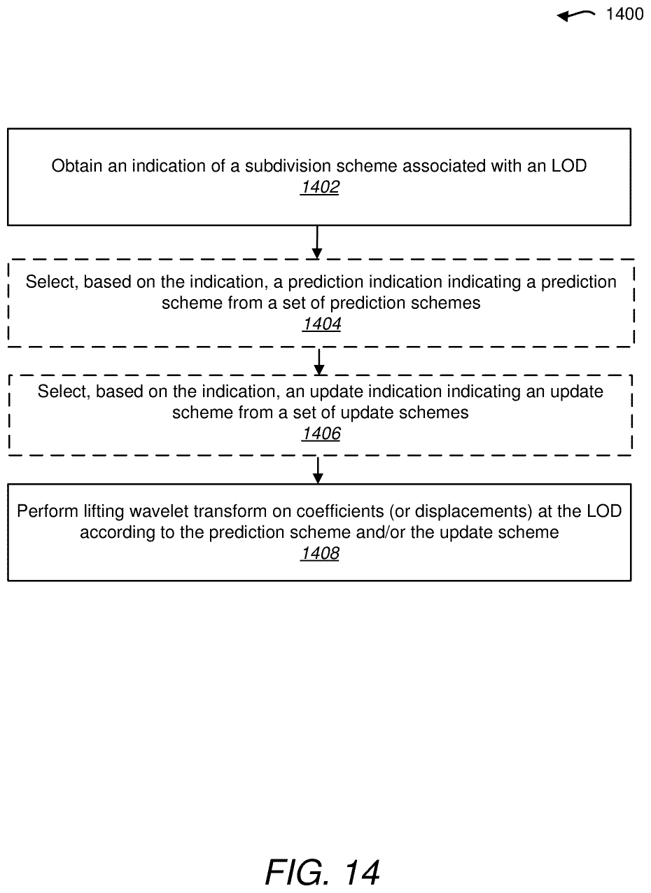

FIG. 14 illustrates a flowchart of a method 1400 for performing a lifting wavelet transform, according to some embodiments. In some examples, method 1400 may be performed by an encoder (e.g., encoder 114 of FIG. 1, encoder 200A of FIG. 2A, or encoder 200B of FIG. 2B). The following descriptions of various steps may refer to operations described above with respect to wavelet transformer 210 of FIG. 2A or FIG. 2B. In some examples, method 1400 may be performed by a decoder (e.g., decoder 120 of FIG. 1 or decoder 300 of FIG. 3). The following descriptions of various steps may refer to operations described above with respect to inverse wavelet transformer 220 of FIG. 2A and FIG. 2B, inverse wavelet transformer 314 of FIG. 3.

At block 1402, an indication of a subdivision scheme associated with an LOD is obtained. For example, the indication of subdivision scheme may be obtained as follows:

| Index | Subdivision Method |
|---|---|
| 0 | NONE |
| 1 | MIDPOINT |
| 2 | LOOP |
| 3 | LS3 |
| 4 . . . 7 | RESERVED |

At block 1404, a prediction indication, indicating a prediction scheme from a set of prediction schemes, is selected based on the indication.

At block 1406, an update indication, indicating an update scheme from a set of update schemes, is selected based on the indication.

In some embodiments, only one of blocks 1404 and 1406 is performed.

In some embodiments, both blocks 1404 and 1406 are performed.

In some embodiments, a table that maps the indication of subdivision scheme to each of the prediction indication and/or the update indication may be obtained to select or set the prediction indication and the update indication. For example, the following table shows an example mappings of subdivision to prediction and/or update scheme:

| Subdivision | Prediction | Update |
|---|---|---|
| Midpoint | Midpoint average | LOD-adaptive and/or valence- |
| (arithmetic) | | based |
| Loop | Similarity-based | Non-adaptive |
| Loop | Similarity-based | LOD-adaptive/valence-based |
| Loop | Similarity-based | LOD-adaptive/valence-based + |
| | | Similarity-based |
| LS3 | Midpoint average | Non-adaptive |
| LS3 | Midpoint average | LOD-adaptive/valence-based |
| LS3 | Similarity-based | Similarity-based |
| Normal-based | Normal-based | LOD-adaptive/valence-based |
| Harmonic | Midpoint | Non-adaptive OR LOD-adaptive/ |
| mean | average + | valence-based |
| | Harmonic-adaptive | |

In some embodiments, each selected update scheme may combine two or more of the plurality of update schemes. Similarly, each selected prediction scheme may combine two or more of the plurality of prediction schemes.

In some embodiments, as an example, if the subdivision scheme is loop, P may be set to 1 to indicate similarity-based prediction and update U may be set to 1 to indicate similarity-based update scheme. The P and U enable/disable flags do not need to have the same value. For example, P=1, U=0; or P=0, U=1.

In some examples, the P and U enable/disable flags do not need to be enabled only for the Loop subdivision method.

In some examples, the determination of P/U enable/disable flags may be different for various subdivision methods. For example, for loop subdivision method, P=1, U=1, but for the normal subdivision, for example, P=1, U=0.

At block 1408, lifting wavelet transform is performed on coefficients (or displacements) at the LOD according to the prediction scheme and/or the update scheme.

In some embodiments, blocks 1402-1406 are performed per LOD. For example, based on an LOD index corresponding to an iteration of the subdivision, the LOD index may be associated with the prediction indication and/or update indication.

In some embodiments, prediction and update schemes may be enabled independently of each other. They can be enabled based on the subdivision method, or based on the subdivision method combined with the user-defined parameter. For example, the subdivision method may enable both similarity-based prediction P and update U, but the user-defined parameter may set U=0; therefore, the final indications may be set as P=1 and U=0. In such an example, the user-defined parameter may override default prediction and update schemes associated with a specific subdivision method.

In some embodiments, the determination of the prediction and/or update scheme may be determined depending on how the subdivision scheme is signaled. For example, the subdivision scheme may be signaled once for the whole sequence, on a frame basis, per different patch, per different LOD level of a specific mesh, patch, etc. Accordingly, when the determination of the prediction and/or update scheme is based on a selected subdivision method, no enabling/disabling indication for each of the prediction and update scheme is required to be sent in the bitstream.

In some embodiments, a separate indication for each of the prediction and update schemes may be signaled in the bitstream for enabling/disabling a respective scheme/method. Each indication may be a binary flag or may be represented by absolute values, a log 2 value, an index to a table, etc. For example, a first indication may select one of a plurality of prediction schemes. For example, a second indication may select one of a plurality of update schemes.

In some embodiments, the pair of prediction weights used in the prediction scheme may be additionally scaled, for example, based on standard deviation values that are computed on the midpoint average prediction and transmitted per LOD.

In some examples, instead of transmitting standard deviation values or other values to use as a scale factor for scaling the prediction weights, other statistics may be derived on the displacements vectors of the vertices such as: mean value, median, variance, root mean square, etc.

In some examples, the scale values of the prediction signaled in a bitstream can be used to derive the scale for update weights. For example, an indication of a scale value may be binary value indicating whether to enable/disable a scaling of one or both of the prediction weights in the prediction scheme. In some example, the indication may be represented by an absolute value, a log 2 value, or an index to a table to indicate a scaling value to scale the prediction weights. For example, separate indications may be signaled to indicate separate scaling values for each of the prediction weights, respectively.

In some examples, the indication(s) of the scaling value may be signaled and represented by a numerator value and a denominator value of the scaling value. The decoder may obtain the scaling value for a prediction weight based on decoding the numerator value and the denominator value of the scaling value.

In some examples, the indication(s) may be delta coded. For example, a first indication of a first scale value for a first prediction weight may be signaled. Then, a second indication of a second scale value for a second prediction weight may be signaled, where the second indication comprises a difference (or delta) between the first scale value and the second scale value. The second indication comprises the difference value that is used by the decoder to obtain the second scale value as a sum of the first scale value and the difference value.

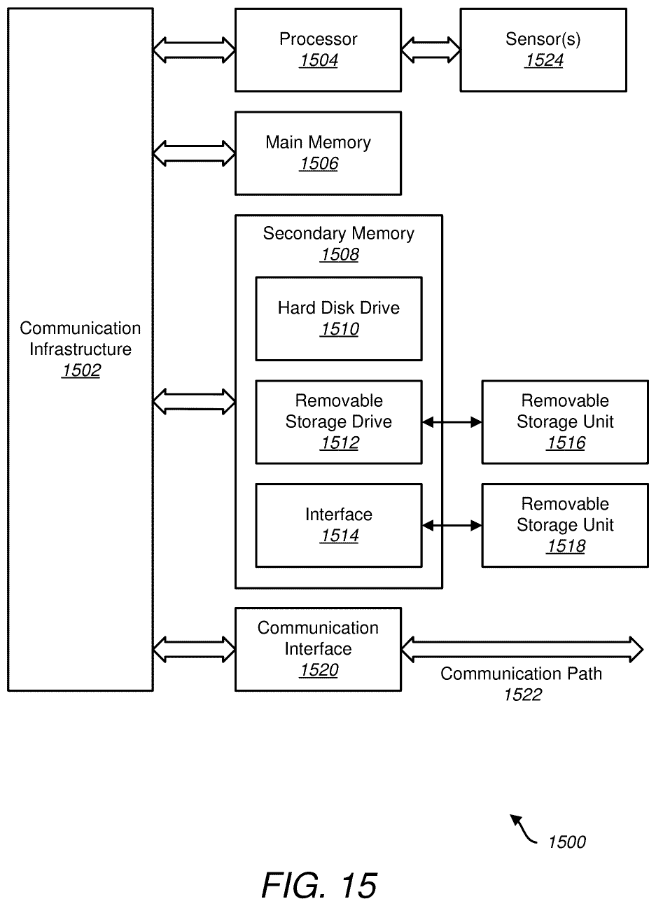

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 1500 is shown in FIG. 15. Blocks depicted in the figures above, such as the blocks in FIG. 1, may execute on one or more computer systems 1500. Furthermore, each of the steps of the flowcharts depicted in this disclosure may be implemented on one or more computer systems 1500. When more than one computer system 1500 is used to implement embodiments of the present disclosure, the computer systems 1500 may be interconnected by one or more networks to form a cluster of computer systems that may act as a single pool of seamless resources. The interconnected computer systems 1500 may form a “cloud” of computers.

Computer system 1500 includes one or more processors, such as processor 1504. Processor 1504 may be, for example, a special purpose processor, general purpose processor, microprocessor, or digital signal processor. Processor 1504 may be connected to a communication infrastructure 1502 (for example, a bus or network). Computer system 1500 may also include a main memory 1506, such as random access memory (RAM), and may also include a secondary memory 1508.

Secondary memory 1508 may include, for example, a hard disk drive 1510 and/or a removable storage drive 1512, representing a magnetic tape drive, an optical disk drive, or the like. Removable storage drive 1512 may read from and/or write to a removable storage unit 1516 in a well-known manner. Removable storage unit 1516 represents a magnetic tape, optical disk, or the like, which is read by and written to by removable storage drive 1512. As will be appreciated by persons skilled in the relevant art(s), removable storage unit 1516 includes a computer usable storage medium having stored therein computer software and/or data.

In alternative implementations, secondary memory 1508 may include other similar means for allowing computer programs or other instructions to be loaded into computer system 1500. Such means may include, for example, a removable storage unit 1518 and an interface 1514. Examples of such means may include a program cartridge and cartridge interface (such as that found in video game devices), a removable memory chip (such as an EPROM or PROM) and associated socket, a thumb drive and USB port, and other removable storage units 1518 and interfaces 1514 which allow software and data to be transferred from removable storage unit 1518 to computer system 1500.

Computer system 1500 may also include a communications interface 1520. Communications interface 1520 allows software and data to be transferred between computer system 1500 and external devices. Examples of communications interface 1520 may include a modem, a network interface (such as an Ethernet card), a communications port, etc. Software and data transferred via communications interface 1520 are in the form of signals which may be electronic, electromagnetic, optical, or other signals capable of being received by communications interface 1520. These signals are provided to communications interface 1520 via a communications path 1522. Communications path 1522 carries signals and may be implemented using wire or cable, fiber optics, a phone line, a cellular phone link, an RF link, and other communications channels.

Computer system 1500 may also include one or more sensor(s) 1524. Sensor(s) 1524 may measure or detect one or more physical quantities and convert the measured or detected physical quantities into an electrical signal in digital and/or analog form. For example, sensor(s) 1524 may include an eye tracking sensor to track the eye movement of a user. Based on the eye movement of a user, a display of a 3D mesh may be updated. In another example, sensor(s) 1524 may include a head tracking sensor to the track the head movement of a user. Based on the head movement of a user, a display of a 3D mesh may be updated. In yet another example, sensor(s) 1524 may include a camera sensor for taking photographs and/or a 3D scanning device, like a laser scanning, structured light scanning, and/or modulated light scanning device. 3D scanning devices may obtain geometry information by moving one or more laser heads, structured light, and/or modulated light cameras relative to the object or scene being scanned. The geometry information may be used to construct a 3D mesh.

As used herein, the terms “computer program medium” and “computer readable medium” are used to refer to tangible storage media, such as removable storage units 1516 and 1518 or a hard disk installed in hard disk drive 1510. These computer program products are means for providing software to computer system 1500. Computer programs (also called computer control logic) may be stored in main memory 1506 and/or secondary memory 1508. Computer programs may also be received via communications interface 1520. Such computer programs, when executed, enable the computer system 1500 to implement the present disclosure as discussed herein. In particular, the computer programs, when executed, enable processor 1504 to implement the processes of the present disclosure, such as any of the methods described herein. Accordingly, such computer programs represent controllers of the computer system 1500.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

1. A method comprising:
obtaining, from a bitstream, an indication of a subdivision scheme associated with a level of detail (LOD), of LODs, for a 3D mesh;
selecting, based on the indication:
a prediction scheme from a plurality of prediction schemes;
an update scheme from a plurality of update schemes; and
performing a lifting wavelet transform on coefficients, obtained from the bitstream and representing displacements of vertices of the 3D mesh, at the LOD according to the prediction scheme and the update scheme to reconstruct the displacements.

2. The method of claim 1, wherein the selecting the prediction scheme and the update scheme comprises:
setting, based on the indication of the subdivision scheme, a first indication selecting the prediction scheme; and
setting, based on the indication of the subdivision scheme, a second indication selecting the update scheme.

3. The method of claim 1, wherein:
the subdivision scheme is one of a plurality of subdivision schemes comprising at least one of no subdivision, midpoint subdivision, loop subdivision, or least squares subdivision surfaces (LS3) subdivision;
the set of prediction schemes comprises one or more of midpoint average, similarity-based prediction, normal-based prediction, or harmonic-adaptive prediction; and
the set of update schemes comprises one or more of LOD-adaptive update, non-adaptive update, or valence-based update.

4. The method of claim 1, wherein the obtaining the indication of the subdivision schemes comprises:
obtaining, from the bitstream, a table that maps each subdivision scheme, of a plurality of subdivision scheme, to one prediction scheme of the set of prediction schemes and to one update scheme of the plurality of update schemes.

5. The method of claim 4, wherein the prediction and update schemes are selected based on the table mapping the indicated subdivision scheme to the prediction and the update schemes.

6. The method of claim 1, wherein the lifting wavelet transform comprises an inverse lifting wavelet transform that iteratively performs, according to an order of LODs of the vertices, lifting operations on the coefficients to reconstruct the displacements.

7. The method of claim 1, further comprising:
obtaining, from the bitstream, a base mesh associated with the 3D mesh;
iteratively subdividing the base mesh to generate vertices of a subdivided base mesh; and
reconstructing a geometry of the 3D mesh based on adding the reconstructed displacements to the vertices of the subdivided base mesh.

8. A decoder comprising:
one or more processors; and
memory storing instructions that, when executed by the one or more processors, cause the decoder to:
obtain, from a bitstream, an indication of a subdivision scheme associated with a level of detail (LOD), of LODs, for a 3D mesh;
select, based on the indication:
a prediction scheme from a plurality of prediction schemes;
an update scheme from a plurality of update schemes; and
perform a lifting wavelet transform on coefficients, obtained from the bitstream and representing displacements of vertices of the 3D mesh, at the LOD according to the prediction scheme and the update scheme to reconstruct the displacements.

9. The decoder of claim 8, wherein to select the prediction scheme and the update scheme, the decoder is further caused to:
set, based on the indication of the subdivision scheme, a first indication selecting the prediction scheme; and
set, based on the indication of the subdivision scheme, a second indication selecting the update scheme.

10. The decoder of claim 8, wherein:
the subdivision scheme is one of a plurality of subdivision schemes comprising at least one of no subdivision, midpoint subdivision, loop subdivision, or least squares subdivision surfaces (LS3) subdivision;
the set of prediction schemes comprises one or more of midpoint average, similarity-based prediction, normal-based prediction, or harmonic-adaptive prediction; and
the set of update schemes comprises one or more of LOD-adaptive update, non-adaptive update, or valence-based update.

11. The decoder of claim 8, wherein to obtain the indication of the subdivision schemes, the decoder is further caused to:
obtain, from the bitstream, a table that maps each subdivision scheme, of a plurality of subdivision scheme, to one prediction scheme of the set of prediction schemes and to one update scheme of the plurality of update schemes.

12. The decoder of claim 11, wherein the prediction and update schemes are selected based on the table mapping the indicated subdivision scheme to the prediction and the update schemes.

13. The decoder of claim 8, wherein the lifting wavelet transform comprises an inverse lifting wavelet transform that iteratively performs, according to an order of LODs of the vertices, lifting operations on the coefficients to reconstruct the displacements.

14. The decoder of claim 8, wherein the decoder is further caused to:
obtain, from the bitstream, a base mesh associated with the 3D mesh;
iteratively subdivide the base mesh to generate vertices of a subdivided base mesh; and
reconstruct a geometry of the 3D mesh based on adding the reconstructed displacements to the vertices of the subdivided base mesh.

15. A non-transitory computer readable medium storing a bitstream, which, when decoded by a decoder, causes the decoder to:
obtain, from a bitstream, an indication of a subdivision scheme associated with a level of detail (LOD), of LODs, for a 3D mesh;
select, based on the indication:
a prediction scheme from a plurality of prediction schemes;
an update scheme from a plurality of update schemes; and
perform a lifting wavelet transform on coefficients, obtained from the bitstream and representing displacements of vertices of the 3D mesh, at the LOD according to the prediction scheme and the update scheme to reconstruct the displacements.

16. The non-transitory computer readable medium of claim 15, wherein to select the prediction scheme and the update scheme, the decoder is further caused to:
set, based on the indication of the subdivision scheme, a first indication selecting the prediction scheme; and
set, based on the indication of the subdivision scheme, a second indication selecting the update scheme.

17. The non-transitory computer readable medium of claim 15, wherein:
the subdivision scheme is one of a plurality of subdivision schemes comprising at least one of no subdivision, midpoint subdivision, loop subdivision, or least squares subdivision surfaces (LS3) subdivision;
the set of prediction schemes comprises one or more of midpoint average, similarity-based prediction, normal-based prediction, or harmonic-adaptive prediction; and
the set of update schemes comprises one or more of LOD-adaptive update, non-adaptive update, or valence-based update.

18. The non-transitory computer readable medium of claim 15, wherein to obtain the indication of the subdivision schemes, the decoder is further caused to:
obtain, from the bitstream, a table that maps each subdivision scheme, of a plurality of subdivision scheme, to one prediction scheme of the set of prediction schemes and to one update scheme of the plurality of update schemes, wherein the prediction and update schemes are selected based on the table mapping the indicated subdivision scheme to the prediction and the update schemes.

19. The non-transitory computer readable medium of claim 15, wherein the lifting wavelet transform comprises an inverse lifting wavelet transform that iteratively performs, according to an order of LODs of the vertices, lifting operations on the coefficients to reconstruct the displacements.

20. The non-transitory computer readable medium of claim 15, wherein the decoder is further caused to:
obtain, from the bitstream, a base mesh associated with the 3D mesh;
iteratively subdivide the base mesh to generate vertices of a subdivided base mesh; and
reconstruct a geometry of the 3D mesh based on adding the reconstructed displacements to the vertices of the subdivided base mesh.
